(19) United States
(12) Patent Application Publication
(10) Pub. No.: US 2025/0180855 A1
(43) Pub. Date: Jun. 5, 2025

(54) OPTICAL SYSTEM, IMAGE PICKUP APPARATUS, ON-BOARD SYSTEM, AND MOVABLE APPARATUS

(71) Applicant: CANON KABUSHIKI KAISHA, Tokyo (JP)

(72) Inventors: Naoto DOUJOU, Tochigi (JP); Masatsugu NAKANO, Tochigi (JP)

(21) Appl. No.: 18/918,193

(22) Filed: Oct. 17, 2024

(30) Foreign Application Priority Data
Dec. 4, 2023 (JP) 2023-204485

(51) Int. Cl. G02B 7/02; B60R 1/26; G02B 9/64; G02B 13/00

(52) U.S. Cl. CPC G02B 7/028; B60R 1/26; G02B 9/64; G02B 13/0045; G02B 13/006

(57) ABSTRACT

An optical system includes, in order from an object side to an image side, a first lens having negative refractive power, a second lens having negative refractive power, a third lens having negative refractive power, a fourth lens having positive refractive power, an aperture stop, a fifth lens having positive refractive power, a sixth lens having negative refractive power, and a seventh lens. A sign of a temperature coefficient of a refractive index for d-line of at least one of the fourth lens and the fifth lens at 20° C. to 40° C. is negative. A sign of a temperature coefficient of a refractive index for the d-line of at least one of the third lens and the sixth lens at 20° C. to 40° C. is positive.

### BACKGROUND

### Technical Field

The present disclosure relates to an optical system suitable for image pickup apparatuses such as digital still cameras, digital video cameras, on-board (in-vehicle) cameras, mobile phone cameras, surveillance cameras, wearable cameras, and medical cameras.

### Description of Related Art

Optical systems for image pickup apparatuses are demanded to have high optical performance regardless of the environmental temperature. Japanese Patent Laid-Open No. 2016-114648 discloses an optical system configured to correct focus position fluctuations caused by changes in environmental temperature.

### SUMMARY

An optical system includes, in order from an object side to an image side, a first lens having negative refractive power, a second lens having negative refractive power, a third lens having negative refractive power, a fourth lens having positive refractive power, an aperture stop, a fifth lens having positive refractive power, a sixth lens having negative refractive power, and a seventh lens. A sign of a temperature coefficient of a refractive index for d-line of at least one of the fourth lens and the fifth lens at 20° C. to 40° C. is negative. A sign of a temperature coefficient of a refractive index for the d-line of at least one of the third lens and the sixth lens at 20° C. to 40° C. is positive. An image pickup apparatus and an on-board system having the above optical system also constitute another aspect of the disclosure. A movable apparatus including the above image pickup apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram of the principal parts of an optical system according to Example 1.

FIGS. 2A to 2C are modulation transfer function (MTF) diagrams at each temperature of the optical system according to Example 1.

FIG. 3 is a schematic diagram of an image pickup apparatus including the optical system according to Example 1.

FIG. 4 is a schematic diagram of the principal parts of an optical system according to Example 2.

FIGS. 5A to 5C are MTF diagrams at each temperature of the optical system according to Example 2.

FIG. 6 is a schematic diagram of the principal parts of an optical system according to Example 3.

FIGS. 7A to 7C are MTF diagrams at each temperature of the optical system according to Example 3.

FIG. 8 is a schematic diagram of the principal parts of an optical system according to Example 4.

FIGS. 9A to 9C are MTF diagrams at each temperature of the optical system according to Example 4.

FIG. 10 is a schematic diagram of the principal parts of an optical system according to Example 5.

FIGS. 11A to 11C are MTF diagrams at each temperature of the optical system according to Example 5.

FIG. 12 is a schematic diagram of an image pickup apparatus according to this embodiment.

FIGS. 13A and 13B are schematic diagrams of a movable apparatus according to this embodiment and illustrate an optical characteristic of the optical system.

FIG. 14 illustrates an example configuration of an on-board (in-vehicle) system according to this embodiment.

### DETAILED DESCRIPTION

Referring now to the accompanying drawings, a detailed description will be given of embodiments according to the disclosure. Each drawing may be drawn at a scale different from the actual scale for convenience. Corresponding elements in respective figures will be designated by the same reference numerals, and a duplicate description thereof will be omitted.

The optical system according to this embodiment includes, in order from the object side to the image side, a first lens having negative refractive power, a second lens having negative refractive power, a third lens having negative refractive power, a fourth lens having positive refractive power, an aperture stop (diaphragm), a fifth lens having positive refractive power, a sixth lens having negative refractive power, and a seventh lens. A temperature coefficient of a refractive index for the d-line at 20° C. to 40° C. of at least one of the fourth lens and the fifth lens is negative, and a temperature coefficient of a refractive index for the d-line at 20° C. to 40° C. of at least one of the third lens and the sixth lens is positive. This configuration can achieve an optical system that can maintain high optical performance even when the temperature fluctuates.

The optical system according to this embodiment can obtain the effect of this example as long as it satisfies at least the above configuration. An optical element that does not contribute to the imaging of the optical system, such as an optical filter or a cover glass, may be disposed on the image side of a (final) lens that is disposed closest to the image plane among the lenses in the optical system. In this embodiment, an optical system includes seven lenses, a first lens to a seventh lens, but this embodiment is applicable to an optical system having eight or more lenses (five or more lenses in the front group or four or more lenses in the rear group), and similar effects can be obtained. Nevertheless, the configuration according to this embodiment is suitable for further miniaturization.

In this embodiment, the following inequality (1) may be satisfied:

$$1.1 < d ndt 6 - dndt 5 < 11.4 \qquad ( 1 )$$

where dndt5 [10⁻⁶/° C.] is a temperature coefficient of the refractive index for the d-line of the fifth lens at 20° C. to 40° C., and dndt6 [10⁻⁶/° C.] is a temperature coefficient of the refractive index for the d-line of the sixth lens at 20° C. to 40° C. In this case,
In this embodiment, the following inequality (2) may be satisfied:

$$- 3.3 < dndt 3 - dndt 4 < 8. \qquad ( 2 )$$

where dndt3 [10⁻⁶/° C.] is a temperature coefficient of the refractive index for the d-line of the third lens at 20° C. to 40° C., and dndt4 [10⁻⁶/° C.] is a temperature coefficient of the refractive index for the d-line of the fourth lens at 20° C. to 40° C.

In a case where neither inequality (1) nor (2) is satisfied, the effect of suppressing focus fluctuations due to temperature fluctuations is likely to decrease.

Inequalities (1) and (2) may be replaced with inequalities (1a) and (2a) below, respectively:

$$1. 5 < d ndt 6 - dndt 5 < 10. \qquad ( 1 a )$$

$$- 3. < d ndt 3 - dndt 4 < 7.0 \qquad ( 2 a )$$

Inequalities (1) and (2) may be replaced with inequalities (1b) and (2b) below, respectively:

$$1. 8 < d ndt 6 - dndt 5 < 9.1 \qquad ( 1 b )$$

$$- 2.6 < d ndt 6 - dndt 5 < 6.4 \qquad ( 2 b )$$

The following inequality (3) may be satisfied in order to suppress astigmatism in the optical system:

$$- 1.1 < f 4 / f 3 < - 0.6 \qquad ( 3 )$$

where f3 is a focal length of the third lens, and f4 is a focal length of the fourth lens.

In a case where inequality (3) is not satisfied, a generated astigmatism amount increases, and the imaging performance may deteriorate.

Inequality (3) may be replaced with inequality (3a) below:

$$- 1. < f 4 / f 3 < - 0.7 \qquad ( 3 a )$$

Inequality (3) may be replaced with inequality (3b) below:

$$- 0.9 < f 4 / f 3 < - 0.7 \qquad ( 3 b )$$

In this embodiment, the following inequality (4) may be satisfied in order to suppress the curvature of field of the optical system:

$$- 1.5 < f 5 / f 6 < - 0.9 \qquad ( 4 )$$

where f5 is a focal length of the fifth lens, and f6 is a focal length of the sixth lens.

In a case where inequality (4) is not satisfied, a curvature-of-field amount increases, and the imaging performance may deteriorate.

Inequality (4) may be replaced with inequality (4a) below:

$$- 1.4 < f 5 / f 6 < - 0.8 \qquad ( 4 a )$$

Inequality (4) may be replaced with inequality (4b) below:

$$- 1.2 < f 5 / f 6 < - 0.7 \qquad ( 4 b )$$

The positive lens (fourth or fifth lens) near the aperture stop S1 may have a large refractive power in order to suppress focus fluctuations due to temperature fluctuations. Thus, in a case where the focal length of the optical system (overall system) is f, the following inequalities (5) and (6) may be satisfied.

$$0.4 < f 4 / f < 2. \qquad ( 5 )$$

$$0.5 < f 5 / f < 1.9 \qquad ( 6 )$$

In a case where neither inequality (5) nor (6) is satisfied, the effect of suppressing focus fluctuations along with temperature fluctuations may deteriorate.

Inequalities (5) and (6) may be replaced with inequalities (5a) and (6a) below:

$$0.5 < f 4 / f < 1.8 \qquad ( 5 a )$$

$$0.6 < f 5 / f < 1.7 \qquad ( 6 a )$$

Inequalities (5) and (6) may be replaced with inequalities (5b) and (6b) below:

$$0.7 < f 4 / f < 1.6 \qquad ( 5 b )$$

$$0.7 < f 5 / f < 1.5 \qquad ( 6 b )$$

In order for a single optical system to achieve the functions of a telephoto lens for imaging the central portion with high resolution and a wide-angle lens for imaging a wide peripheral range, this embodiment uses a wide-angle lens configured to control distortion and have a high resolution at the central portion. The second lens has an aspheric shape in which the refractive power of the negative lens increases from the center to the periphery. The following inequality (7) may be satisfied:

$$- 4. < f 2 / f < - 1. \qquad ( 7 )$$

where f2 is a focal length of the second lens.

In a case where inequality (7) is not satisfied, the resolution at the central portion may decrease.

Inequality (7) may be replaced with inequality (7a) below:

$$- 3.6 < f 2 / f < 1.4 \qquad ( 7 a )$$

Inequality (7) may be replaced with inequality (7b) below:

$$- 3.6 < f 2 / f - 1.4 \qquad ( 7 b )$$

In the case of an aspheric lens having a shape like the second lens, the manufacturing cost tends to increase as the volume and diameter increase. Thus, in each example, the first lens has a weak refractive power, which has the effect of lowering the heights of off-axis rays without significantly affecting off-axis aberrations. The following inequality (8) may be satisfied:

$$- 13.7 < f 1 / f < - 6.8 \qquad ( 8 )$$

where f1 is a focal length of the first lens.

Inequality (8) may be replaced with inequality (8a):

$$- 12. < f 1 / f < - 4.2 \qquad ( 8 a )$$

Inequality (8) may be replaced with inequality (8b):

$$- 11. < f 1 / f < - 4. \qquad ( 8 b )$$

In this embodiment, the effect of each example is enhanced when the following inequality (9) is satisfied:

$$1. < {α}_{op} / {α}_{co} < 1.4 \qquad ( 9 )$$

where αₒₚ [1/° C.] is a linear expansion coefficient of the lens barrel material and α_{co} [1/° C.] is a linear expansion coefficient of the cover material.

In a case where inequality (9) is not satisfied, a focus fluctuation amount and a correction amount of the lens when the temperature fluctuates are significantly different, and thus a focus shift may occur when the temperature fluctuates.

Inequality (9) may be replaced with inequality (9a) below:

$$1.1 < {α}_{op} / {α}_{co} < 1.35 \qquad ( 9 a )$$

Inequality (9) may be replaced with inequality (9b) below:

$$1.1 < {α}_{op} / {α}_{co} < 1.35 \qquad ( 9 a )$$

A description will now be given of detailed examples of the optical system according to this embodiment.

### Example 1

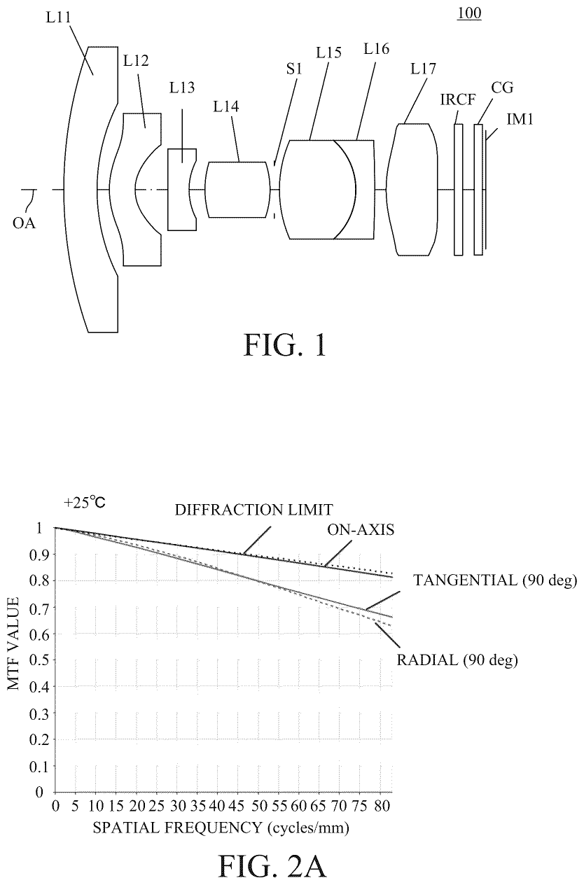

FIG. 1 is a schematic diagram of the principal part of an optical system 100 according to Example 1 in a section having an optical axis OA. In FIG. 1, a left side is an object side (front side), and a right side is an image side (rear side). The optical system 100 includes, in order from the object side to the image side, a front group, an aperture stop S1, and a rear group. The front group includes, in order from the object side to the image side, a first lens L11 having negative refractive power, a second lens L12 having negative refractive power, a third lens L13 having negative refractive power, and a fourth lens L14 having positive refractive power. The rear group includes, in order from the object side to the image side, a cemented lens of a fifth lens L15 having positive refractive power and a sixth lens L16 having negative refractive power, and a seventh lens L17. In each example, the cemented lens is tightly attached by applying an adhesive or the like between the positive lens and the negative lens. The presence or absence of a filter and a wavelength range do not affect the form of each example.

The optical system 100 according to this embodiment is an imaging optical system for an image pickup apparatus. The imaging surface of an image sensor is disposed at a position of an image plane IM1. IRCF, which is disposed on the object side of the image plane IM1, represents an infrared light cut filter, and CG represents a cover glass. These optical elements do not contribute to imaging of the optical system 100. The optical system 100 according to this example may be used as a projection optical system in a projection apparatus such as a projector. In this case, a display surface of a display element such as a liquid crystal panel is disposed at a position of the image plane IM1.

The optical specifications according to this example (numerical example 1) are set to a focal length of 3.3 mm, an image-side F-number (Fno) 2.8, and a half angle of view of 0 to 90 degrees. A designed wavelength range is 486.1 to 656.27 nm. A glass material for each example is an optical glass from Ohara Corporation and HOYA Corporation, but another equivalent product may also be used. T2 at the end of each glass material indicates −40° C., and T3 indicates +85° C.

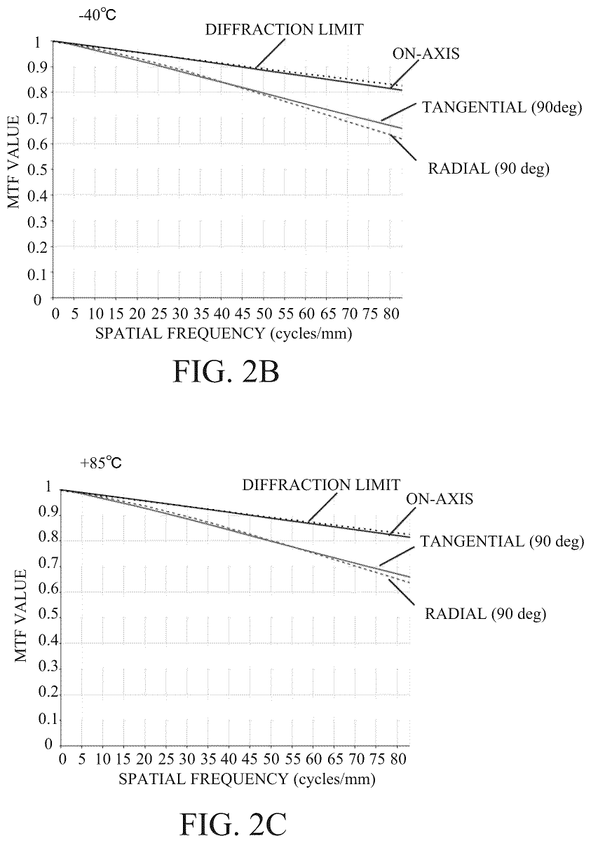

FIGS. 2A to 2C illustrate modulation transfer function (MTF) curves at respective temperatures in this example. Here, three cases are illustrated: FIG. 2A illustrates normal temperature (25° C.), FIG. 2B illustrates low temperature (−40° C.), and FIG. 2C illustrates high temperature (85° C.). In FIGS. 2A to 2C, a horizontal axis indicates a spatial frequency [cycles/mm], and a vertical axis indicates an MTF value (contrast value). The MTF value at each temperature is 40% or more at a frequency of 83 lp/mm, which is half the Nyquist frequency at a pixel pitch of 3.0 μm, and good imaging performance is obtained.

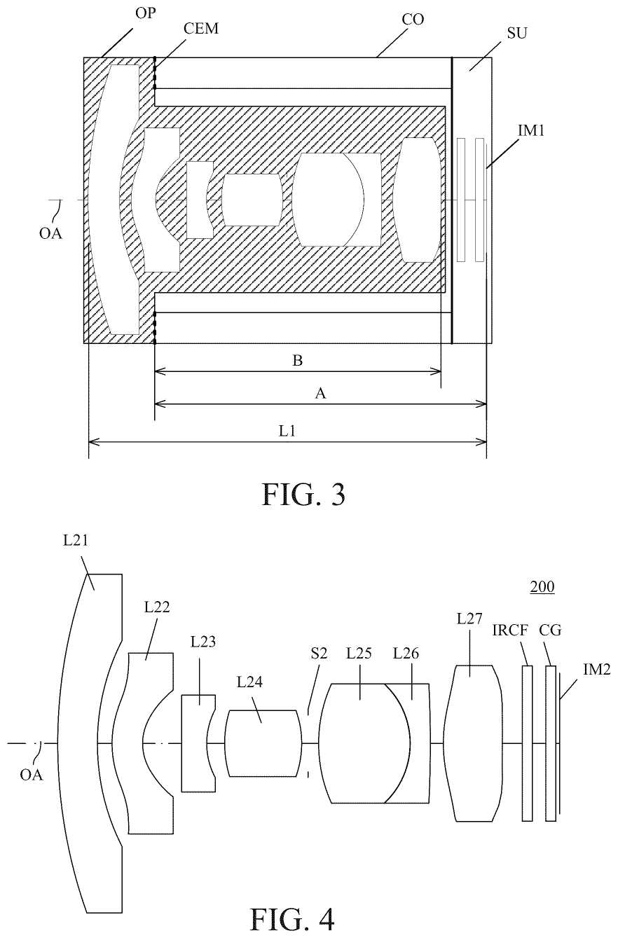

FIG. 3 is a configuration diagram of an image pickup apparatus having the optical system 100 according to this example. The image pickup apparatus according to this example has a lens barrel OP, an image sensor having a sensor surface disposed on an image plane IM1, a sensor unit SU including board wirings, and a cover material CO connecting the lens barrel OP and the image plane IM1. Depending on the image pickup apparatus, the sensor unit SU and the cover material CO may be the same. Even in that case, this example is applicable. After the positions of the lens barrel OP and the sensor surface (image plane IM1) are adjusted, they are fixed by an adhesive portion CEM.

Conventionally, the focus fluctuation of the optical system due to temperature is corrected by the lengths of the cover material CO and the lens barrel OP and a difference between the linear expansion coefficients of their materials. Here, a distance A from the adhesive portion CEM to the image plane IM1, a distance B from the adhesive portion CEM to the image side surface of the final lens, and the material properties (linear expansion coefficients) αₒₚ and α_{co} (αₛᵤ) of the lens barrel OP, cover material CO, and sensor unit SU. In this case, a correction amount ΔL at a temperature change amount ΔT can be calculated by the following equation (A). Here, it is assumed that the cover material CO and the sensor unit SU are made of the same material.

$$Δ L = ( A \times Δ T \times {α}_{co} ) - ( B \times Δ T \times {α}_{op} ) \qquad ( A )$$

In a case where the focus fluctuation amount due to the optical system during temperature fluctuation and the correction amount ΔL have the same sign and amount, a focus shift during temperature fluctuation can be corrected.

In using a sensor with high pixel density and small pitches, it is necessary to release the heat from the sensor portion toward the outside air side, so it is useful to employ metal materials for the cover material CO and sensor unit SU. The lens barrel material may be made of a resin material that can be inexpensively manufactured. On-board lenses and surveillance cameras are demanded to use materials that are resistant to the effects of heat, humidity, and ultraviolet rays. Materials that meet this condition include a material (PPA/PPE) made by alloying high-heat-resistant polyamide resin (PPA) with polyphenylene ether resin (PPE). Linear expansion coefficients of corrosion-resistant and weather-resistant painted metal cover materials (ADC12, ADC10, A1070, etc.) are about 2 to 2.5×10⁻⁵ (1/° C.), while linear expansion coefficients of weather-resistant resin barrel materials (PPA/PPE) are about 2.6×10⁻⁵ (1/° C.). Thus, a difference in linear expansion coefficient between the weather-resistant metal cover material and the resin barrel material (PPA/PPE) may be small.

In this case, as expressed by equation (A), in order to increase the correction amount ΔL, it is necessary to increase the distance A from the adhesive portion CEM to the sensor surface IM1 and to decrease the distance B from the adhesive portion CEM to the image side surface of the seventh lens. However, due to the optical performance and size specifications, it is difficult to significantly reduce the numerical value of the distance A or B, which is longer than the overall lens length L1 (the length from the first lens to the sensor surface).

As described above, in a case where there is no significant difference in the linear expansion coefficient of materials such as the lens barrel OP, the cover material CO, and the sensor unit SU, it is difficult to obtain a necessary correction amount ΔL. Thus, each example proposes a configuration for obtaining high optical performance in suppressing focus fluctuations due to temperature fluctuations as much as possible by properly selecting a focal length of a lens and a lens material.

Here, for one lens (single lens) in the optical system, the following equation (B) holds:

$$Δ f = β \times Δ T \times f \qquad ( B )$$

where Δf is a change amount in focal length when the environmental temperature changes, β is a coefficient, ΔT is a change amount in environmental temperature, and f is a focal length before the environmental temperature changes.

The coefficient β in equation (B) is expressed as follows:

$$β = α - dndt / ( N - 1 ) \qquad ( C )$$

where N is a refractive index for the d-line (wavelength 587.56 nm) for a single lens, α is a linear expansion coefficient, and dndt is a temperature coefficient of the refractive index for the d-line.

Since the linear expansion coefficients for the sensor components and lens barrel materials are positive, the sensor position moves in the positive direction when the temperature rises. In response, a positive lens may use a material such that a temperature coefficient β is positive and a negative lens may use a material such that a temperature coefficient β is negative. Since the linear expansion coefficient for the normal glass material is positive, the temperature coefficient dndt for the refractive index of the positive lens may be negative and the temperature coefficient dndt for the refractive index of the negative lens may be positive.

In this example, the first lens L11, which is a negative lens, converges a wide angle of view, and the second lens L12 employs an aspheric surface that increases the refractive power of the negative lens from the central portion to the periphery. Thereby, this example controls the distortion characteristic. The third lens L13 and the fourth lens L14 correct astigmatism, and the fourth lens L14 and the fifth lens L15 near the aperture stop S1 correct spherical aberration with their large refractive powers. The fifth lens L15 and the sixth lens L16 in the rear group correct longitudinal chromatic aberration, and the seventh lens L17 corrects curvature of field with its aspheric surface, thereby achieving high imaging performance. In particular, since the fourth lens L14 and the fifth lens L15 near the aperture stop S1 have large positive refractive powers, at least one of the temperature coefficients dndt for the refractive indices may be negative. Since the third lens L3 and the sixth lens L6 near the aperture stop S1 have large negative refractive powers, at least one of the temperature coefficients for the refractive indices dndt may be positive. In a case where each condition is not met, the effect of suppressing focus fluctuations due to temperature fluctuations may decrease.

In order to suppress focus fluctuations due to temperature fluctuations, a temperature coefficient difference between the refractive indices of the positive lens and the negative lens near the aperture stop S1 may be large. In a relationship among a focal length and glass material characteristic of each lens and the linear expansion coefficients of the lens barrel material and cover material described above, the distance A from the adhesive portion CEM to the sensor surface (image plane IM1) may be smaller than the overall lens length (the distance from the first lens to the sensor surface).

### Example 2

FIG. 4 is a schematic diagram of the principal part of an optical system 200 according to Example 2 in a section having the optical axis OA. The optical system 200 includes, in order from the object side to the image side, a front group, an aperture stop S2, and a rear group. The front group includes, in order from the object side to the image side, a first lens L21 having negative refractive power, a second lens L22 having negative refractive power, a third lens L23 having negative refractive power, and a fourth lens L24 having positive refractive power. The rear group includes, in order from the object side to the image side, a cemented lens of a fifth lens L25 having positive refractive power and a sixth lens L26 having negative refractive power, and a seventh lens L27.

The optical specifications according to this example (numerical example 2) are set to a focal length of 3.3 mm, an image-side Fno of 2.8, and a half angle of view of 0 to 90 degrees. A designed wavelength range is 486.1 to 656.27 nm. T2 at the end of each glass material indicates −40° C., and T3 indicates +85° C.

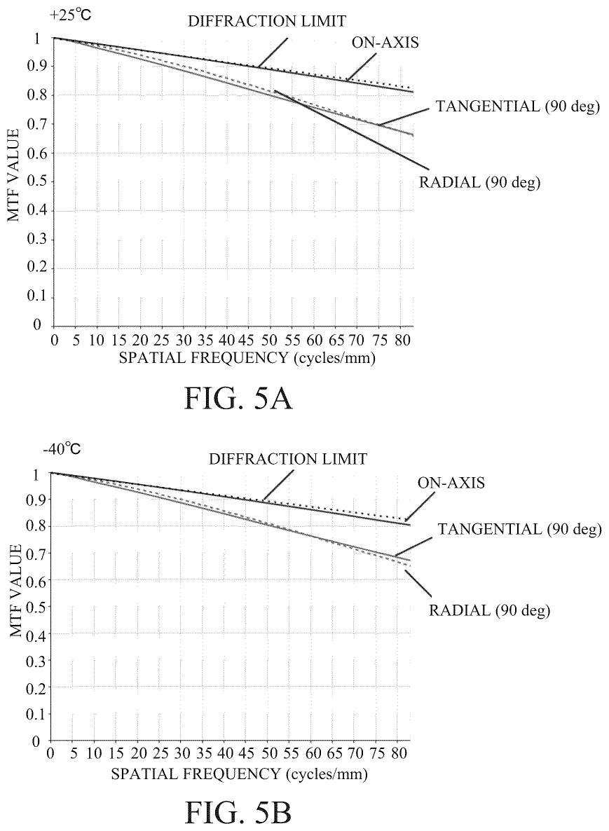

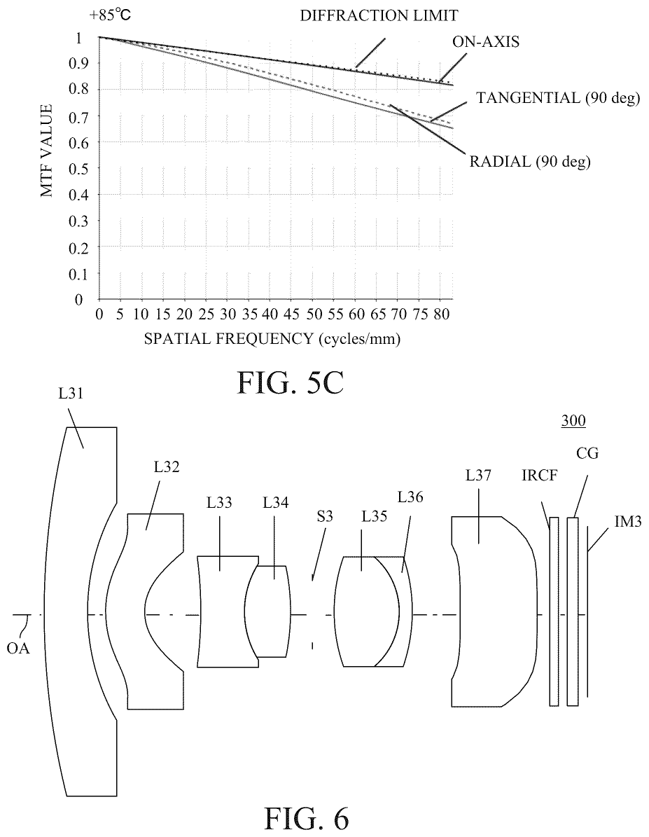

FIGS. 5A to 5C illustrate MTF curves at respective temperatures in this example. Here, three cases are illustrated: FIG. 5A illustrates normal temperature (25° C.), FIG. 5B illustrates low temperature (−40° C.), and FIG. 5C illustrates high temperature (85° C.). In FIGS. 5A to 5C, a horizontal axis indicates a spatial frequency [cycles/mm], and a vertical axis indicates an MTF value (contrast value). The MTF value at each temperature is 40% or more at a frequency of 83 lp/mm, which is half the Nyquist frequency at a pixel pitch of 3.0 μm, and good imaging performance is obtained.

### Example 3

FIG. 6 is a schematic diagram of the principal part of an optical system 300 according to Example 3 in a section having the optical axis OA. The optical system 300 includes, in order from the object side to the image side, a front group, an aperture stop S3, and a rear group. The front group includes, in order from the object side to the image side, a first lens L31 having negative refractive power, a second lens L32 having negative refractive power, and a cemented lens of a third lens L33 having negative refractive power and a fourth lens L34 having positive refractive power. The rear group includes, in order from the object side to the image side, a cemented lens of a fifth lens L35 having positive refractive power and a sixth lens L36 having negative refractive power, and a seventh lens L37.

The optical specifications according to this example (numerical example 3) are set to a focal length of 4.5 mm, an image-side Fno of 2.8, and a half angle of view of 0 to 90 degrees. A designed wavelength range is 486.1 to 656.27 nm. T2 at the end of each glass material indicates −40° C., and T3 indicates +85° C.

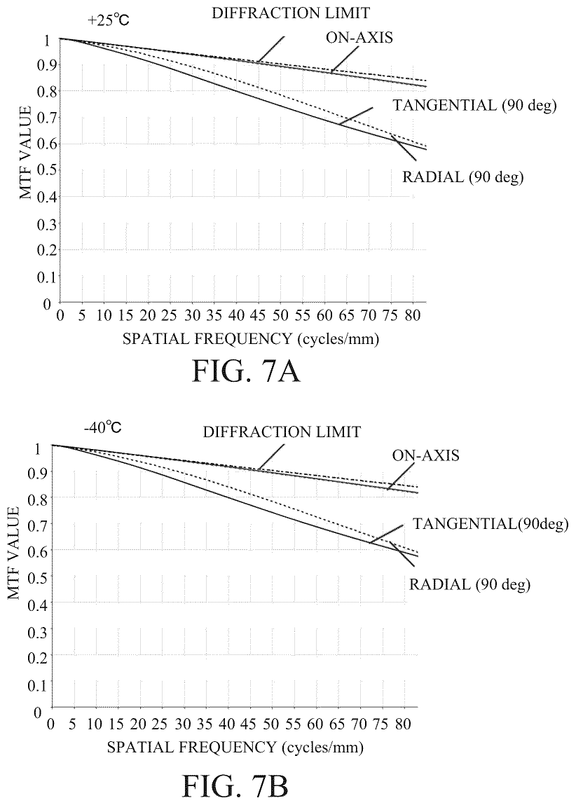

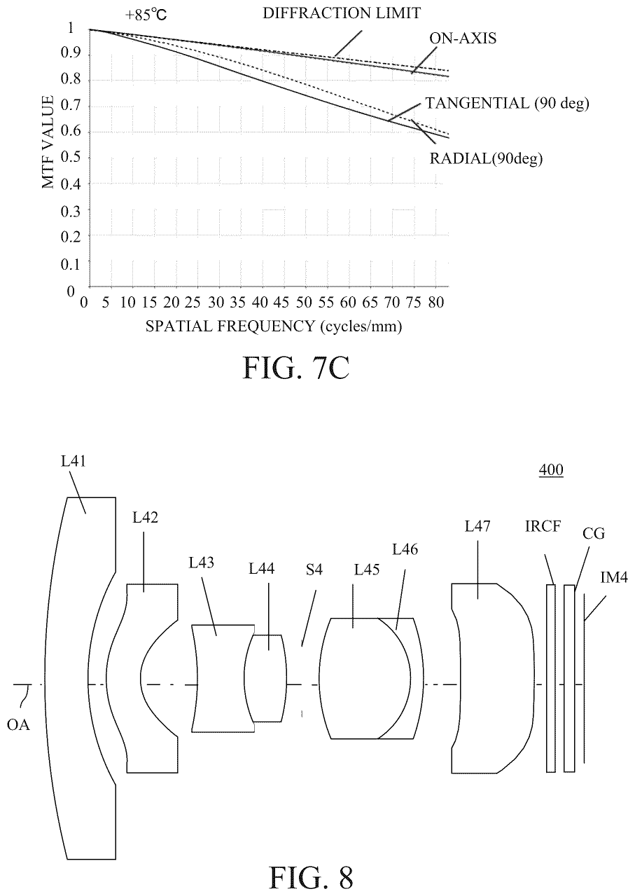

FIGS. 7A to 7C illustrate MTF curves at respective temperatures in this example. Here, three cases are illustrated: FIG. 7A illustrates normal temperature (25° C.), FIG. 7B illustrate low temperature (−40° C.), and FIG. 7C illustrates high temperature (85° C.). In FIGS. 7A to 7C, a horizontal axis indicates a spatial frequency [cycles/mm], and a vertical axis indicates an MTF value (contrast value). The MTF value at each temperature is 40% or more at a frequency of 83 lp/mm, which is half the Nyquist frequency for a pixel pitch of 3.0 μm, and good imaging performance is obtained.

### Example 4

FIG. 8 is a schematic diagram of the principal part of an optical system 400 according to Example 4 in a section having the optical axis OA. The optical system 400 includes, in order from the object side to the image side, a front group, an aperture stop S4, and a rear group. The front group includes, in order from the object side to the image side, a first lens L41 having negative refractive power, a second lens L42 having negative refractive power, and a cemented lens of a third lens L43 having negative refractive power and a fourth lens L44 having positive refractive power. The rear group includes, in order from the object side to the image side, a cemented lens of a fifth lens L45 having positive refractive power and a sixth lens L46 having negative refractive power, and a seventh lens L47.

The optical specifications according to this example (numerical example 4) are set to a focal length of 4.6 mm, an image-side Fno of 2.8, and a half angle of view of 0 to 90 degrees. A designed wavelength range is 486.1 to 656.27 nm. T2 at the end of each glass material indicates −40° C., and T3 indicates +85° C.

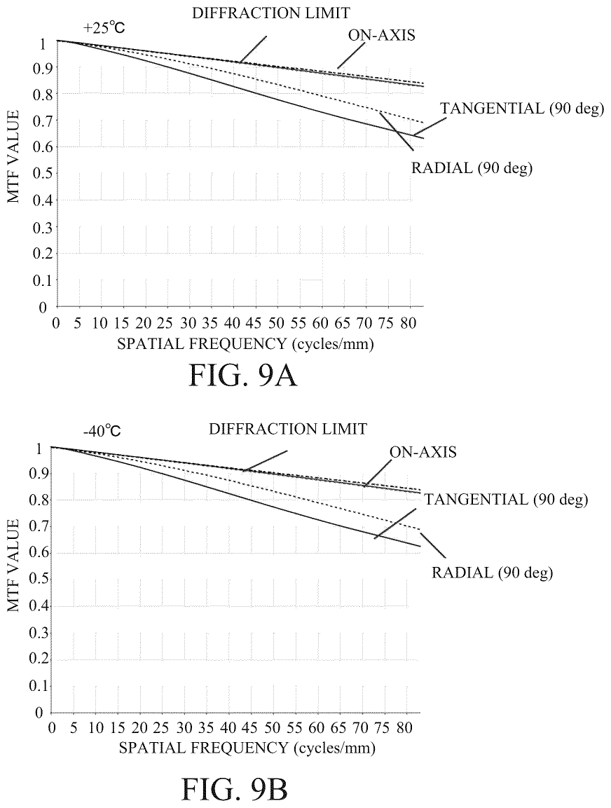

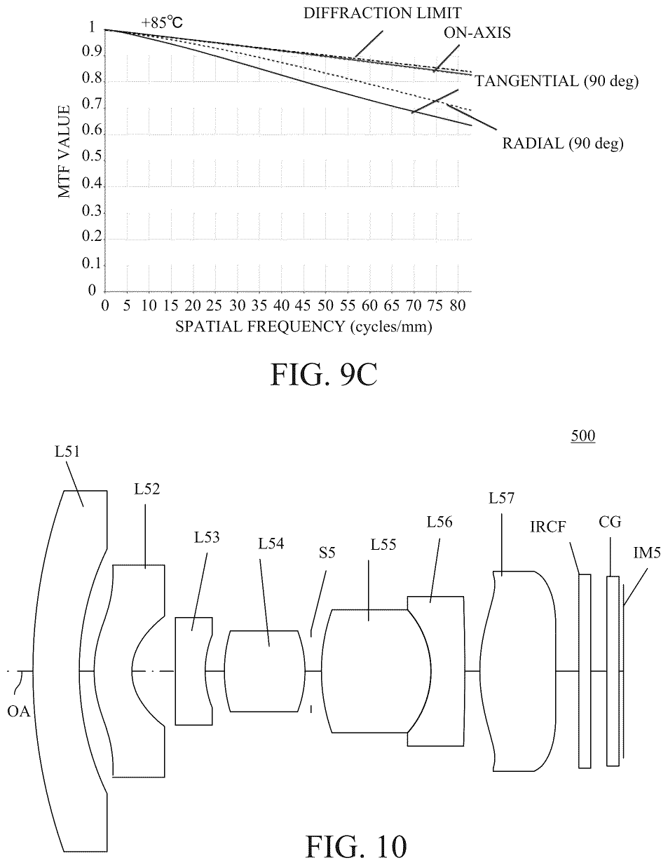

FIGS. 9A to 9C illustrate MTF curves at respective temperatures in this example. Here, three cases are illustrated: FIG. 9A illustrates normal temperature (25° C.), FIG. 9B illustrates low temperature (−40° C.), and FIG. 9C illustrates high temperature (85° C.). In FIGS. 9A to 9C, a horizontal axis indicates a spatial frequency [cycles/mm], and a vertical axis indicates an MTF value (contrast value). The MTF value at each temperature is 40% or more at a frequency of 83 lp/mm, which is half the Nyquist frequency at a pixel pitch of 3.0 μm, and good imaging performance is obtained.

### Example 5

FIG. 10 is a schematic diagram of the principal part of an optical system 500 according to Example 5 in a section having the optical axis OA. The optical system 500 includes, in order from the object side to the image side, a front group, an aperture stop S5, and a rear group. The front group includes, in order from the object side to the image side, a first lens L51 having negative refractive power, a second lens L52 having negative refractive power, a third lens L53 having negative refractive power, and a fourth lens L54 having positive refractive power. The rear group includes, in order from the object side to the image side, a cemented lens of a fifth lens L55 having positive refractive power and a sixth lens L56 having negative refractive power, and a seventh lens L57.

The optical specifications according to this example (numerical example 5) are set to a focal length of 3.3 mm, an image-side Fno of 2.8, and a half angle of view of 0 to 60 degrees. A designed wavelength range is 486.1 to 656.27 nm. T2 at the end of each glass material indicates −40° C., and T3 indicates +85° C.

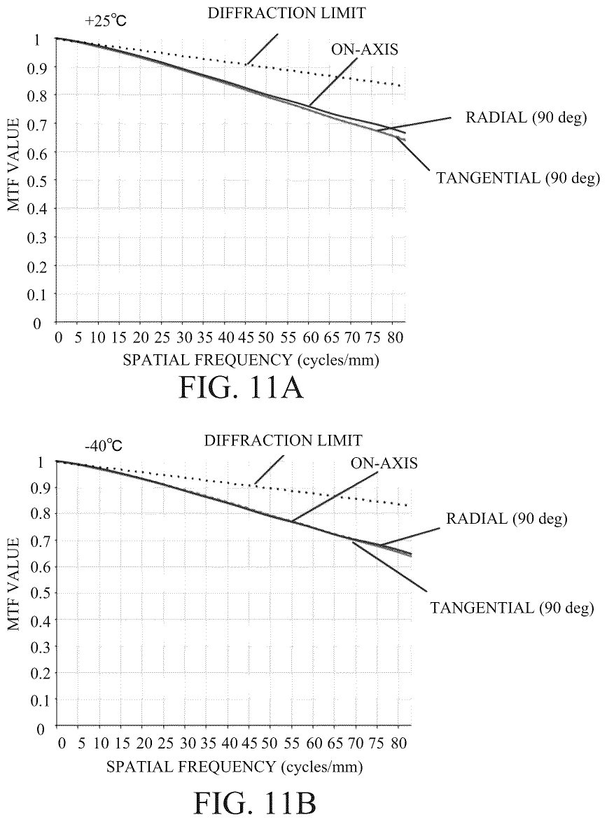

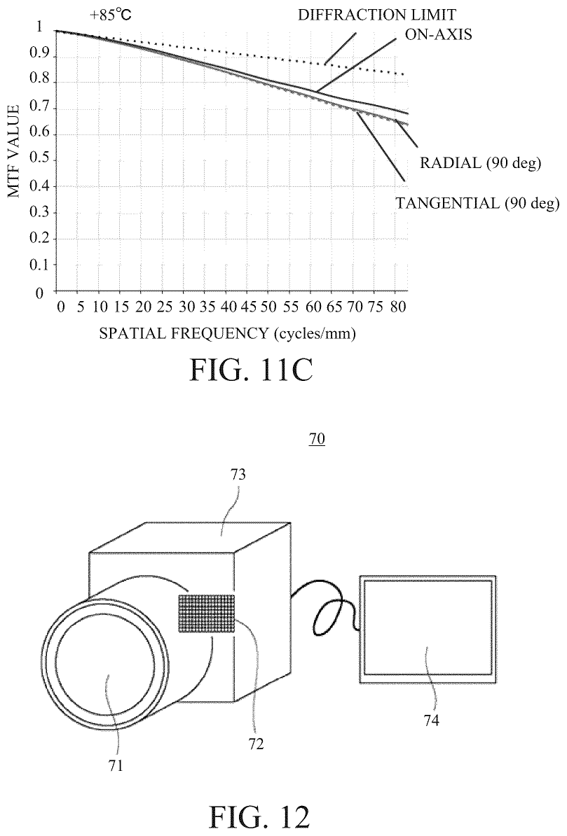

FIGS. 11A to 11C illustrate MTF (Modulation Transfer Function) curves at respective temperatures in this example. Here, three cases are illustrated: FIG. 11A illustrates normal temperature (25° C.), FIG. 11B illustrates low temperature (−40° C.), and FIG. 11C illustrates high temperature (85° C.). In FIGS. 11A to 11C, a horizontal axis indicates a spatial frequency [cycles/mm], and a vertical axis indicates an MTF value (contrast value). The MTF value at each temperature is 40% or more at a frequency of 83 lp/mm, which is half the Nyquist frequency for a pixel pitch of 3.0 μm, and good imaging performance is obtained.

A description will now be given of numerical examples 1 to 5 corresponding to Examples 1 to 5. In each numerical example, a surface number is the order of each optical surface when counted from the object surface. r [mm] indicates a radius of curvature of an i-th optical surface, and d [mm] indicates a distance between i-th and (i+1)-th optical surfaces. A material (glass material) of each lens in each numerical example may be another material having equivalent physical properties.

“E±P” in each numerical example means “×10^{±P}.” An aspheric shape in each example is expressed by the following equation (D):

$$Z = \frac{( 1 / R ) {h}^{2}}{1 + \sqrt{1 - ( 1 + k ) {( 1 / R )}^{2} {h}^{2}}} + {Ah}^{4} + {Bh}^{6} + {Ch}^{8} + {Dh}^{10} + {Eh}^{12} + {Fh}^{14} + {Gh}^{16} + {Hh}^{18} + {Ih}^{20} \qquad ( D )$$

where a z-axis is set to an optical axis direction, an h-axis is perpendicular to the optical axis, and a light traveling direction is positive, R is a paraxial radius of curvature, k is a conic coefficient, and A to I are fourth to twentieth order aspheric coefficients.

### Numerical Example 1

NUMERICAL DATA AT ROOM TEMPERATURE (+25° C.)

| | | r | d | Glass Material |
|---|---|---|---|---|
| Object Surface | | — | 2000.0 | AIR |
| L11 | Spheric Surface | 20.189 | 1.578 | SLAL21_OHARA |
| | Spheric Surface | 9.042 | 0.585 | AIR |
| L12 | Aspheric | 4.155 | 1.219 | MBACD12_HOYA |
| | Surface 11 | | | |
| | Aspheric | 2.025 | 1.555 | AIR |
| | Surface 12 | | | |
| L13 | Spheric Surface | 1000.000 | 1.000 | LBSL7_OHARA |
| | Spheric Surface | 2.938 | 0.533 | AIR |
| | Plane | Plane | 0.220 | AIR |
| L14 | Spheric Surface | 4.491 | 3.085 | SBAL3_OHARA |
| | Spheric Surface | −4.033 | 0.200 | AIR |
| S1 | Plane | Plane | 0.244 | AIR |
| L15 | Spheric Surface | 5.825 | 3.620 | SFPM2_OHARA |
| | Spheric Surface | −3.125 | 0.002 | Adhesive |
| L16 | Spheric Surface | −3.125 | 0.892 | STIH53W_OHARA |
| | Spheric Surface | −52.818 | 0.545 | AIR |
| L17 | Aspheric | 6.318 | 2.431 | MBACD12_HOYA |
| | Surface 13 | | | |
| | Aspheric | −35.344 | 0.794 | AIR |
| | Surface 14 | | | |
| IRCF | Plane | Plane | 0.400 | IRCF |
| | Plane | Plane | 0.540 | AIR |
| CG | Plane | Plane | 0.400 | CG |
| | Plane | Plane | 0.150 | AIR |
| IM1 | Plane | Plane | — | — |

NUMERICAL DATA AT LOW TEMPERATURE (−40° C.)

| | | r | d | Glass Material |
|---|---|---|---|---|
| Object Surface | | — | 2000.0 | ‘AIRT2’ |
| L11 | Spheric Surface | 20.183 | 1.577 | SLAL21_OHARA |
| | Spheric Surface | 9.039 | 0.581 | ‘AIRT2’ |
| L12 | Aspheric | 4.153 | 1.219 | ‘BACD12T2’ |
| | Surface 11 | | | |
| | Aspheric | 2.025 | 1.554 | ‘AIRT2’ |
| | Surface 12 | | | |
| L13 | Spheric Surface | −999.653 | 1.000 | ‘LBSL7T2’ |
| | Spheric Surface | 2.937 | 0.533 | ‘AIRT2’ |
| | Plane | Plane | 0.218 | ‘AIRT2’ |
| L14 | Spheric Surface | 4.488 | 3.083 | ‘SBAL3T2’ |
| | Spheric Surface | −4.031 | 0.198 | ‘AIRT2’ |
| S1 | Plane | Plane | 0.241 | ‘AIRT2’ |
| L15 | Spheric Surface | 5.819 | 3.617 | ‘SFPM2T2’ |
| | Spheric Surface | −3.123 | 0.002 | Adhesive |
| L16 | Spheric Surface | −3.124 | 0.892 | ‘TIH53WT2’ |
| | Spheric Surface | −52.836 | 0.545 | ‘AIRT2’ |
| L17 | Aspheric | 6.315 | 2.430 | ‘BACD12T2’ |
| | Surface 13 | | | |
| | Aspheric | −35.330 | 0.789 | ‘AIRT2’ |
| | Surface 14 | | | |
| IRCF | Plane | Plane | 0.400 | IRCF |
| | Plane | Plane | 0.538 | ‘AIRT2’ |
| CG | Plane | Plane | 0.400 | CG |
| | Plane | Plane | 0.150 | ‘AIRT2’ |
| IM1 | Plane | Plane | — | — |

NUMERICAL DATA AT HIGH TEMPERATURE (+85° C.)

| | | r | d | Glass Material |
|---|---|---|---|---|
| Object Surface | | — | 2000.0 | ‘AIRT3’ |
| L11 | Spheric Surface | 20.196 | 1.578 | SLAL21_OHARA |
| | Spheric Surface | 9.045 | 0.589 | ‘AIRT3’ |
| L12 | Aspheric | 4.157 | 1.220 | ‘BACD12T3’ |
| | Surface 11 | | | |
| | Aspheric | 2.026 | 1.556 | ‘AIRT3’ |
| | Surface 12 | | | |
| L13 | Spheric Surface | −1000.381 | 1.000 | ‘LBSL7T3' |
| | Spheric Surface | 2.939 | 0.534 | ‘AIRT3’ |
| | Plane | Plane | 0.222 | ‘AIRT3’ |
| L14 | Spheric Surface | 4.494 | 3.087 | ‘SBAL3T3’ |
| | Spheric Surface | −4.035 | 0.202 | ‘AIRT3’ |
| S1 | Plane | Plane | 0.247 | ‘AIRT3’ |
| L15 | Spheric Surface | 5.830 | 3.623 | ‘SFPM2T3’ |
| | Spheric Surface | −3.127 | 0.002 | Adhesive |
| L16 | Spheric Surface | −3.127 | 0.893 | ‘TIH53WT3’ |
| | Spheric Surface | −52.799 | 0.548 | ‘AIRT3’ |
| L17 | Aspheric | 6.321 | 2.432 | ‘BACD12T3’ |
| | Surface 13 | | | |
| | Aspheric | −35.360 | 0.799 | ‘AIRT3’ |
| | Surface 14 | | | |
| IRCF | Plane | Plane | 0.400 | IRCF |
| | Plane | Plane | 0.542 | ‘AIRT3’ |
| CG | Plane | Plane | 0.400 | CG |
| | Plane | Plane | 0.150 | ‘AIRT3’ |
| IM1 | Plane | Plane | — | — |

ASPHERIC COEFFICIENTS WHEN TEMPERATURE FLUCTUATES
+25° C.

| | Aspheric | Aspheric | Aspheric | Aspheric |
|---|---|---|---|---|
| | Surface 11 | Surface 12 | Surface 13 | Surface 14 |
| R | 4.155 | 2.025 | 6.318 | −35.344 |
| k | −0.957 | −0.636 | −0.536 | 10.000 |
| A | 4.3931E−03 | 8.6115E−03 | 5.3875E−03 | 2.2435E−02 |
| B | −1.8805E−03 | 9.0907E−03 | −5.4839E−03 | −1.2124E−02 |
| C | 3.9279E−04 | −2.1284E−02 | 2.0343E−03 | 3.0039E−03 |
| D | −2.1186E−04 | 1.9096E−02 | −4.5133E−04 | −4.6812E−04 |
| E | 5.5462E−05 | −1.0925E−02 | 5.7732E−05 | 4.5314E−05 |
| F | −7.3440E−06 | 3.9210E−03 | −3.9963E−06 | −2.5333E−06 |
| G | 5.3183E−07 | −8.3569E−04 | 1.1794E−07 | 6.3810E−08 |
| H | −2.02338E−08 | 9.63085E−05 | 0 | 0 |
| I | 3.17496E−10 | −4.61118E−06 | 0 | 0 |

−40° C.

| | Aspheric | Aspheric | Aspheric | Aspheric |
|---|---|---|---|---|
| | Surface 11 | Surface 12 | Surface 13 | Surface 14 |
| R | 4.153 | 2.025 | 6.315 | −35.330 |
| k | −0.957 | −0.636 | −0.536 | 10.000 |
| A | 4.3985E−03 | 8.6221E−03 | 5.3941E−03 | 9.6362E+00 |
| B | −1.8843E−03 | 9.1092E−03 | −5.4951E−03 | −1.4712E+01 |
| C | 3.9391E−04 | −2.1345E−02 | 2.0401E−03 | 8.5169E+00 |
| D | −2.1263E−04 | 1.9166E−02 | −4.5299E−04 | −2.4425E+00 |
| E | 5.5711E−05 | −1.0974E−02 | 5.7991E−05 | 3.7133E−01 |
| F | −7.3830E−06 | 3.9418E−03 | −4.0175E−06 | −2.8675E−02 |
| G | 5.3509E−07 | −8.40802E−04 | 1.1866E−07 | 8.8574E−04 |
| H | −2.03743E−08 | 9.69768E−05 | 0 | 0 |
| I | 3.19960E−10 | −4.64696E−06 | 0 | 0 |

+85° C.

| | Aspheric | Aspheric | Aspheric | Aspheric |
|---|---|---|---|---|
| | Surface 11 | Surface 12 | Surface 13 | Surface 14 |
| R | 4.157 | 2.026 | 6.321 | −35.360 |
| k | −0.957 | −0.636 | −0.536 | 10.000 |
| A | 4.3871E−03 | 8.5997E−03 | 5.3801E−03 | 2.2405E−02 |
| B | −1.8762E−03 | 9.0698E−03 | −5.4714E−03 | −1.2097E−02 |
| C | 3.9153E−04 | −2.1216E−02 | 2.0278E−03 | 2.9942E−03 |
| D | −2.1098E−04 | 1.9017E−02 | −4.4947E−04 | −4.6619E−04 |
| E | 5.5183E−05 | −1.0870E−02 | 5.7441E−05 | 4.5085E−05 |
| F | −7.3003E−06 | 3.8977E−03 | −3.9725E−06 | −2.5182E−06 |
| G | 5.2818E−07 | −8.29949E−04 | 1.1713E−07 | 6.3372E−08 |
| H | −2.00765E−08 | 9.55594E−05 | 0 | 0 |
| I | 3.14738E−10 | −4.57111E−06 | 0 | 0 |

REFRACTIVE INDEX WHEN TEMPERATURE FLUCTUATES

| | WAVELENGTH (nm) | | |
|---|---|---|---|
| GLASS NAME | 680 | 587.56 | 470 |
| SLAL21_OHARA | 1.697817 | 1.703 | 1.714471 |
| MBACD12_HOYA | 1.579291 | 1.58313 | 1.591455 |
| STIH53W_OHARA | 1.833727 | 1.84666 | 1.878166 |
| SFPM2_OHARA | 1.591805 | 1.59522 | 1.602703 |
| LBSL7_OHARA | 1.513136 | 1.51633 | 1.523132 |
| SBAL3_OHARA | 1.567194 | 1.571351 | 1.58059 |
| NBK7_SCHOTT | 1.513615 | 1.5168 | 1.523605 |
| ‘AIRT2’ | 1.000341 | 1.000343 | 1.000346 |
| ‘AIRT3’ | 1.000222 | 1.000223 | 1.000225 |
| ‘SLAL21T2’ | 1.69792 | 1.703087 | 1.714517 |
| ‘SLAL21T3’ | 1.698647 | 1.703853 | 1.715381 |
| ‘BACD12T2’ | 1.579607 | 1.583436 | 1.591738 |
| ‘BACD12T3’ | 1.579872 | 1.583729 | 1.592094 |
| ‘LBSL7T2’ | 1.51337 | 1.516557 | 1.523341 |
| ‘LBSL7T3’ | 1.513749 | 1.516957 | 1.523792 |
| ‘SBAL3T2’ | 1.56778 | 1.571927 | 1.581138 |
| ‘SBAL3T3’ | 1.567501 | 1.571674 | 1.580958 |
| ‘SFPM2T2’ | 1.592724 | 1.596133 | 1.6036 |
| ‘SFPM2T3’ | 1.591787 | 1.595214 | 1.602726 |
| ‘NBK7T2’ | 1.513971 | 1.517149 | 1.523937 |
| ‘NBK7T3’ | 1.514125 | 1.517324 | 1.524162 |
| ‘TIH53WT2’ | 1.834336 | 1.847225 | 1.87859 |
| ‘TIH53WT3’ | 1.83417 | 1.847165 | 1.878857 |

### Numerical Example 2

NUMERICAL DATA AT ROOM TEMPERATURE (+25° C.)

| | | r | d | Glass Material |
|---|---|---|---|---|
| Object Surface | | — | 2000.000 | AIR |
| L21 | Spheric Surface | 20.282 | 1.581 | SLAL21_OHARA |
| | Spheric Surface | 9.062 | 0.580 | AIR |
| L22 | Aspheric | 4.155 | 1.219 | MBACD12_HOYA |
| | Surface 21 | | | |
| | Aspheric | 2.031 | 1.554 | AIR |
| | Surface 22 | | | |
| L23 | Spheric Surface | −3033.208 | 1.000 | LBSL7_OHARA |
| | Spheric Surface | 2.876 | 0.513 | AIR |
| | Plane | Plane | 0.200 | AIR |
| L24 | Spheric Surface | 4.502 | 3.071 | SBAL14_OHARA |
| | Spheric Surface | −3.918 | 0.254 | AIR |
| S2 | Plane | Plane | 0.418 | AIR |
| L25 | Spheric Surface | 5.782 | 3.648 | SFPN2_OHARA |
| | Spheric Surface | −3.257 | 0.002 | Adhesive |
| L26 | Spheric Surface | −3.257 | 0.800 | STIH53W_OHARA |
| | Spheric Surface | −51.774 | 0.521 | AIR |
| L27 | Aspheric | 6.553 | 2.349 | AIR |
| | Surface 23 | | | |
| | Aspheric | −34.987 | 0.794 | AIR |
| | Surface 24 | | | |
| IRCF | Plane | Plane | 0.400 | IRCF |
| | Plane | Plane | 0.540 | AIR |
| CG | Plane | Plane | 0.400 | CG |
| | Plane | Plane | 0.150 | AIR |
| IM2 | Plane | Plane | — | — |

NUMERICAL DATA AT LOW TEMPERATURE (−40° C.)

| | | r | d | Glass Material |
|---|---|---|---|---|
| Object Surface | | — | 2000.000 | ‘AIRT2’ |
| L21 | Spheric Surface | 20.275 | 1.580 | SLAL21_OHARA |
| | Spheric Surface | 9.059 | 0.576 | ‘AIRT2’ |
| L22 | Aspheric | 4.153 | 1.219 | ‘BACD12T2’ |
| | Surface 21 | | | |
| | Aspheric | 2.030 | 1.553 | ‘AIRT2’ |
| | Surface 22 | | | |
| L23 | Spheric Surface | −3032.157 | 1.000 | ‘LBSL7T2’ |
| | Spheric Surface | 2.875 | 0.513 | ‘AIRT2’ |
| | Plane | Plane | 0.198 | ‘AIRT2’ |
| L24 | Spheric Surface | 4.500 | 3.069 | ‘SBAL14T2’ |
| | Spheric Surface | −3.916 | 0.252 | ‘AIRT2’ |
| S2 | Plane | Plane | 0.418 | ‘AIRT2’ |
| L25 | Spheric Surface | 5.777 | 3.646 | ‘SFPM2T2’ |
| | Spheric Surface | −3.255 | 0.002 | Adhesive |
| L26 | Spheric Surface | −3.255 | 0.800 | ‘TIH53WT2’ |
| | Spheric Surface | −51.790 | 0.518 | ‘AIRT2’ |
| L27 | Aspheric | 6.551 | 2.348 | ‘BACD12T2’ |
| | Surface 23 | | | |
| | Aspheric | −34.972 | 0.793 | ‘AIRT2’ |
| | Surface 24 | | | |
| IRCF | Plane | Plane | 0.400 | IRCF |
| | Plane | Plane | 0.539 | ‘AIRT2’ |
| CG | Plane | Plane | 0.400 | CG |
| | Plane | Plane | 0.150 | ‘AIRT2’ |
| IM2 | Plane | Plane | — | — |

NUMERICAL DATA AT HIGH TEMPERATURE (+85° C.)

| | | r | d | Glass Material |
|---|---|---|---|---|
| Object Surface | | — | 2000.000 | ‘AIRT3’ |
| L21 | Spheric Surface | 20.288 | 1.581 | SLAL21_OHARA |
| | Spheric Surface | 9.065 | 0.584 | ‘AIRT3’ |
| L22 | Aspheric | 4.157 | 1.220 | BACD12T3’ |
| | Surface 21 | | | |
| | Aspheric | 2.032 | 1.555 | ‘AIRT3’ |
| | Surface 22 | | | |
| L23 | Spheric Surface | −3034.363 | 1.000 | 'LBSL7T3’ |
| | Spheric Surface | 2.877 | 0.514 | ‘AIRT3’ |
| | Plane | Plane | 0.202 | ‘AIRT3’ |
| L24 | Spheric Surface | 4.504 | 3.072 | 'SBAL14T3' |
| | Spheric Surface | −3.920 | 0.255 | ‘AIRT3’ |
| S2 | Plane | Plane | 0.418 | ‘AIRT3’ |
| L25 | Spheric Surface | 5.788 | 3.651 | 'SFPM2T3' |
| | Spheric Surface | −3.259 | 0.002 | Adhesive |
| L26 | Spheric Surface | −3.259 | 0.800 | 'TIH53WT3' |
| | Spheric Surface | −51.759 | 0.524 | ‘AIRT3’ |
| L27 | Aspheric | 6.556 | 2.350 | 'BACD12T3' |
| | Surface 23 | | | |
| | Aspheric | −35.003 | 0.795 | ‘AIRT3’ |
| | Surface 24 | | | |
| IRCF | Plane | Plane | 0.400 | IRCF |
| | Plane | Plane | 0.541 | ‘AIRT3’ |
| CG | Plane | Plane | 0.400 | CG |
| | Plane | Plane | 0.150 | ‘AIRT3’ |
| IM2 | Plane | Plane | — | — |

ASPHERIC COEFFICIENTS WHEN TEMPERATURE FLUCTUATES
+25° C.

| | Aspheric | Aspheric | Aspheric | Aspheric |
|---|---|---|---|---|
| | Surface 21 | Surface 22 | Surface 23 | Surface 24 |
| R | 4.155 | 2.031 | 6.553 | −34.987 |
| k | −0.958 | −0.630 | −0.520 | 10.000 |
| A | 4.3922E−03 | 8.4604E−03 | 5.2762E−03 | 2.2519E−02 |
| B | −1.8806E−03 | 9.1282E−03 | −5.1181E−03 | −1.2083E−02 |
| C | 3.9285E−04 | −2.1303E−02 | 1.7707E−03 | 2.9640E−03 |
| D | −2.1189E−04 | 1.9124E−02 | −3.6287E−04 | −4.5868E−04 |
| E | 5.5470E−05 | −1.0947E−02 | 4.2095E−05 | 4.4454E−05 |
| F | −7.3453E−06 | 3.9307E−03 | −2.5927E−06 | −2.5180E−06 |
| G | 5.3196E−07 | −8.3829E−04 | 6.7731E−08 | 6.5063E−08 |
| H | −2.02410E−08 | 9.66860E−05 | 0 | 0 |
| I | 3.17658E−10 | −4.63383E−06 | 0 | 0 |

−40° C.

| | Aspheric | Aspheric | Aspheric | Aspheric |
|---|---|---|---|---|
| | Surface 21 | Surface 22 | Surface 23 | Surface 24 |
| R | 4.153 | 2.030 | 6.551 | −34.972 |
| k | −0.958 | −0.630 | −0.520 | 10.000 |
| A | 4.3975E−03 | 8.4707E−03 | 5.2827E−03 | 2.2546E−02 |
| B | −1.8844E−03 | 9.1467E−03 | −5.1285E−03 | −1.2107E−02 |
| C | 3.9397E−04 | −2.1363E−02 | 1.7757E−03 | 2.9725E−03 |
| D | −2.1266E−04 | 1.9194E−02 | −3.6420E−04 | −4.6036E−04 |
| E | 5.5719E−05 | −1.0996E−02 | 4.2284E−05 | 4.4654E−05 |
| F | −7.3843E−06 | 3.9516E−03 | −2.6065E−06 | −2.5313E−06 |
| G | 5.3522E−07 | −8.43419E−04 | 6.8146E−08 | 6.5461E−08 |
| H | −2.03815E−08 | 9.73570E−05 | 0 | 0 |
| I | 3.20123E−10 | −4.66979E−06 | 0 | 0 |

+85° C.

| | Aspheric | Aspheric | Aspheric | Aspheric |
|---|---|---|---|---|
| | Surface 21 | Surface 22 | Surface 23 | Surface 24 |
| R | 4.157 | 2.032 | 6.556 | −35.003 |
| k | −0.958 | −0.630 | −0.520 | 10.000 |
| A | 4.3861E−03 | 8.4487E−03 | 5.2690E−03 | 2.2488E−02 |
| B | −1.8763E−03 | 9.1072E−03 | −5.1064E−03 | −1.2055E−02 |
| C | 3.9159E−04 | −2.1234E−02 | 1.7650E−03 | 2.9545E−03 |
| D | −2.1101E−04 | 1.9045E−02 | −3.6138E−04 | −4.5678E−04 |
| E | 5.5190E−05 | −1.0891E−02 | 4.1883E−05 | 4.4230E−05 |
| F | −7.3016E−06 | 3.9073E−03 | −2.5773E−06 | −2.5030E−06 |
| G | 5.2831E−07 | −8.32532E−04 | 6.7266E−08 | 6.4616E−08 |
| H | −2.00836E−08 | 9.59340E−05 | 0 | 0 |
| I | 3.14898E−10 | −4.59357E−06 | 0 | 0 |

REFRACTIVE INDEX WHEN TEMPERATURE FLUCTUATES

| | WAVELENGTH (nm) | | |
|---|---|---|---|
| GLASS NAME | 680 | 587.56 | 470 |
| SLAL21_OHARA | 1.697817 | 1.703 | 1.714471 |
| MBACD12_HOYA | 1.579291 | 1.58313 | 1.591455 |
| STIH53W_OHARA | 1.833727 | 1.84666 | 1.878166 |
| SFPM2_OHARA | 1.591805 | 1.59522 | 1.602703 |
| LBSL7_OHARA | 1.513136 | 1.51633 | 1.523132 |
| SBAL14_OHARA | 1.564913 | 1.568832 | 1.577438 |
| NBK7_SCHOTT | 1.513615 | 1.5168 | 1.523605 |
| ‘AIRT2’ | 1.000341 | 1.000343 | 1.000346 |
| ‘AIRT3’ | 1.000222 | 1.000223 | 1.000225 |
| ‘SLAL21T2’ | 1.69792 | 1.703087 | 1.714517 |
| ‘SLAL21T3’ | 1.698647 | 1.703853 | 1.715381 |
| ‘BACD12T2’ | 1.579607 | 1.583436 | 1.591738 |
| ‘BACD12T3’ | 1.579872 | 1.583729 | 1.592094 |
| ‘LBSL7T2’ | 1.51337 | 1.516557 | 1.523341 |
| ‘LBSL7T3’ | 1.513749 | 1.516957 | 1.523792 |
| ‘SBAL14T2’ | 1.56535 | 1.56926 | 1.57784 |
| ‘SBAL14T3’ | 1.565361 | 1.569295 | 1.577943 |
| ‘SFPM2T2’ | 1.592724 | 1.596133 | 1.6036 |
| ‘SFPM2T3’ | 1.591787 | 1.595214 | 1.602726 |
| ‘NBK7T2’ | 1.513971 | 1.517149 | 1.523937 |
| ‘NBK7T3’ | 1.514125 | 1.517324 | 1.524162 |
| ‘TIH53WT2’ | 1.834336 | 1.847225 | 1.87859 |
| ‘TIH53WT3’ | 1.83417 | 1.847165 | 1.878857 |

### Numerical Example 3

NUMERICAL DATA AT ROOM TEMPERATURE (+25° C.)

| | | r | d | Glass Material |
|---|---|---|---|---|
| Object Surface | | — | 2000.000 | AIR |
| L31 | Spheric Surface | 35.117 | 2.000 | SLAL21_OHARA |
| | Spheric Surface | 9.996 | 0.825 | AIR |
| L32 | Aspheric | 4.854 | 1.796 | MBACD12_HOYA |
| | Surface 31 | | | |
| | Aspheric | 2.290 | 2.584 | AIR |
| | Surface 32 | | | |
| L33 | Spheric Surface | −19.216 | 2.008 | STIM2_OHARA |
| | Spheric Surface | 4.136 | 0.002 | Adhesive |
| L34 | Plane | 4.136 | 2.124 | SLAH60MQ_OHARA |
| | Spheric Surface | −9.984 | 1.000 | AIR |
| S3 | Spheric Surface | Plane | 1.000 | AIR |
| L35 | Plane | 7.606 | 2.997 | SPHM52Q_OHARA |
| | Spheric Surface | −3.348 | 0.002 | Adhesive |
| L36 | Spheric Surface | −3.348 | 0.600 | STIH53W_OHARA |
| | Spheric Surface | −7.851 | 2.202 | AIR |
| L37 | Aspheric | −197.087 | 3.547 | MBACD12_HOYA |
| | Surface 33 | | | |
| | Aspheric | −33.493 | 0.571 | AIR |
| | Surface 34 | | | |
| IRCF | Plane | Plane | 0.400 | IRCF |
| | Plane | Plane | 0.410 | AIR |
| CG | Plane | Plane | 0.500 | CG |
| | Plane | Plane | 0.435 | AIR |
| IM3 | Plane | Plane | 0.000 | — |

NUMERICAL DATA AT LOW TEMPERATURE (−40° C.)

| | | r | d | Glass Material |
|---|---|---|---|---|
| Object Surface | | — | 2000.000 | ‘AIRT2’ |
| L31 | Spheric Surface | 35.107 | 2.000 | ‘SLAL21T2’ |
| | Spheric Surface | 9.993 | 0.825 | ‘AIRT2’ |
| L32 | Aspheric Surface 31 | 4.852 | 1.796 | ‘BACD12T2’ |
| | Aspheric Surface | 2.289 | 2.584 | AIRT2’ |
| | 32 | | | |
| L33 | Spheric Surface | −19.207 | 2.008 | ‘STIM2T2’ |
| | Spheric Surface | 4.134 | 0.002 | Adhesive |
| L34 | Plane | 4.134 | 2.124 | ‘AH60MQT2’ |
| | Spheric Surface | −9.978 | 1.000 | ‘AIRT2’ |
| S3 | Spheric Surface | Plane | 1.000 | ‘AIRT2’ |
| L35 | Plane | 7.602 | 2.997 | ‘PHM52QT2’ |
| | Spheric Surface | −3.347 | 0.002 | Adhesive |
| L36 | Spheric Surface | −3.347 | 0.600 | ‘TIH53WT2’ |
| | Spheric Surface | −7.847 | 2.202 | ‘AIRT2’ |
| L37 | Aspheric Surface | −197.006 | 3.547 | ‘BACD12T2’ |
| | 33 | | | |
| | Aspheric Surface | −33.479 | 0.571 | ‘AIRT2’ |
| | 34 | | | |
| IRCF | Plane | Plane | 0.400 | IRCF |
| | Plane | Plane | 0.410 | ‘AIRT2’ |
| CG | Plane | Plane | 0.500 | CG |
| | Plane | Plane | 0.435 | ‘AIRT2’ |
| IM3 | Plane | Plane | 0.000 | — |

NUMERICAL DATA AT HIGH TEMPERATURE (+85° C.)

| | | r | d | Glass Material |
|---|---|---|---|---|
| Object Surface | | − | 2000.000 | ‘AIRT3’ |
| L31 | Spheric Surface | 35.129 | 2.001 | ‘SLAL21T3’ |
| | Spheric Surface | 9.999 | 0.832 | ‘AIRT3’ |
| L32 | Aspheric Surface 31 | 4.857 | 1.797 | ‘BACD12T3’ |
| | Aspheric Surface 32 | 2.291 | 2.585 | ‘AIRT3’ |
| L33 | Spheric Surface | −19.225 | 2.009 | ‘STIM2T3’ |
| | Spheric Surface | 4.138 | 0.002 | Adhesive |
| L34 | Plane | 4.138 | 2.125 | ‘AH60MQT3’ |
| | Spheric Surface | −9.990 | 1.003 | ‘AIRT3’ |
| S3 | Spheric Surface | Plane | 1.004 | ‘AIRT3’ |
| L35 | Plane | 7.610 | 2.999 | ‘PHM52QT3’ |
| | Spheric Surface | −3.350 | 0.002 | Adhesive |
| L36 | Spheric Surface | −3.350 | 0.600 | ‘TIH53WT3’ |
| | Spheric Surface | −7.856 | 2.206 | ‘AIRT3’ |
| L37 | Aspheric Surface 33 | −197.177 | 3.549 | ‘BACD12T3’ |
| | Aspheric Surface 34 | −33.508 | 0.574 | ‘AIRT3’ |
| IRCF | Plane | Plane | 0.400 | IRCF |
| | Plane | Plane | 0.411 | ‘AIRT3’ |
| CG | Plane | Plane | 0.500 | CG |
| | Plane | Plane | 0.436 | ‘AIRT3’ |
| IM3 | Plane | Plane | 0.000 | — |

ASPHERIC COEFFICIENTS WHEN TEMPERATURE FLUCTUATES

| | | | |
|---|---|---|---|
| Aspheric | Aspheric | Aspheric | Aspheric |
| Surface 31 | Surface 32 | Surface 33 | Surface 34 |

+25° C.

| | | | | |
|---|---|---|---|---|
| R | 4.854 | 2.290 | −197.087 | −33.493 |
| k | −2.055 | −0.585 | 0.000 | 0.000 |
| A | 2.9797E−03 | 4.3897E−03 | −4.3508E−04 | 7.2846E−03 |
| B | −1.4630E−04 | 1.0111E−03 | −1.2523E−03 | −2.5525E−03 |
| C | −5.6253E−05 | −1.2289E−03 | 3.1940E−04 | 2.9193E−04 |
| D | 5.5854E−06 | 2.7508E−04 | −4.6867E−05 | −1.9271E−05 |
| E | −2.1591E−07 | −2.9317E−05 | 3.3157E−06 | 6.8799E−07 |
| F | 3.2717E−09 | 1.2539E−06 | −9.3447E−08 | −1.0252E−08 |
| G | 0.0000E+00 | 0.0000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

−40° C.

| | | | | |
|---|---|---|---|---|
| R | 4.852 | 2.289 | −197.006 | −33.479 |
| k | −2.055 | −0.585 | 0.000 | 0.000 |
| A | 2.9833E−03 | 4.3951E−03 | −4.3561E−04 | 7.2935E−03 |
| B | −1.4660E−04 | 1.0131E−03 | −1.2548E−03 | −2.5577E−03 |
| C | −5.6413E−05 | −1.2324E−03 | 3.2031E−04 | 2.9276E−04 |
| D | 5.6059E−06 | 2.7609E−04 | −4.7039E−05 | −1.9342E−05 |
| E | −2.1688E−07 | −2.9448E−05 | 3.3306E−06 | 6.9108E−07 |
| F | 3.2891E−09 | 1.2605E−06 | −9.3942E−08 | −1.0306E−08 |
| G | 0.0000E+00 | 0.00000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

+85° C.

| | | | | |
|---|---|---|---|---|
| R | 4.857 | 2.291 | −197.177 | −33.508 |
| k | −2.055 | −0.585 | 0.000 | 0.000 |
| A | 2.9756E−03 | 4.3836E−03 | −4.3448E−04 | 7.2746E−03 |
| B | −1.4596E−04 | 1.0088E−03 | −1.2494E−03 | −2.5466E−03 |
| C | −5.6072E−05 | −1.2250E−03 | 3.1837E−04 | 2.9099E−04 |
| D | 5.5624E−06 | 2.7394E−04 | −4.6674E−05 | −1.9192E−05 |
| E | −2.1483E−07 | −2.9169E−05 | 3.2990E−06 | 6.8453E−07 |
| F | 3.2523E−09 | 1.2464E−06 | −9.2890E−08 | −1.0191E−08 |
| G | 0.0000E+00 | 0.00000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

REFRACTIVE INDEX WHEN TEMPERATURE FLUCTUATES

| | WAVELENGTH (nm) | | |
|---|---|---|---|
| GLASS NAME | 680 | 587.56 | 470 |
| SLAL21_OHARA | 1.697817 | 1.703 | 1.714471 |
| MBACD12_HOYA | 1.579291 | 1.58313 | 1.591455 |
| STIM2_OHARA | 1.613638 | 1.620041 | 1.634924 |
| SLAH60MQ_OHARA | 1.825568 | 1.834 | 1.853466 |
| SPHM52Q_OHARA | 1.614189 | 1.618 | 1.626295 |
| STIH53W_OHARA | 1.833727 | 1.84666 | 1.878166 |
| SBSL7_OHARA | 1.513149 | 1.51633 | 1.523134 |
| ‘AIRT2’ | 1.000341 | 1.000343 | 1.000346 |
| ‘AIRT3’ | 1.000222 | 1.000223 | 1.000225 |
| ‘SLAL21T2’ | 1.69792 | 1.703087 | 1.714517 |
| ‘SLAL21T3’ | 1.698647 | 1.703853 | 1.715381 |
| ‘BACD12T2’ | 1.579607 | 1.583436 | 1.591738 |
| ‘BACD12T3’ | 1.579872 | 1.583729 | 1.592094 |
| ‘STIM2T2’ | 1.614043 | 1.620426 | 1.635246 |
| ‘STIM2T3’ | 1.614147 | 1.620579 | 1.635547 |
| ‘AH60MQT2’ | 1.826238 | 1.834643 | 1.854038 |
| ‘AH60MQT3’ | 1.825939 | 1.834407 | 1.853972 |
| ‘PHM52QT2’ | 1.614789 | 1.618592 | 1.626866 |
| ‘PHM52QT3’ | 1.614498 | 1.618324 | 1.626656 |
| ‘TIH53WT2’ | 1.834336 | 1.847225 | 1.87859 |
| ‘TIH53WT3’ | 1.83417 | 1.847165 | 1.878857 |
| ‘SBSL7T2’ | 1.513513 | 1.516687 | 1.523472 |
| ‘SBSL7T3’ | 1.513642 | 1.516836 | 1.523673 |

### Numerical Example 4

NUMERICAL DATA AT ROOM TEMPERATURE (+25 ° C.)

| | | r | d | Glass Material |
|---|---|---|---|---|
| Object Surface | | — | 2000.000 | AIR |
| L41 | Spheric Surface | 34.161 | 2.000 | SLAL21_OHARA |
| | Spheric Surface | 10.122 | 0.845 | AIR |
| L42 | Aspheric Surface 41 | 4.943 | 1.585 | MBACD12_HOYA |
| | Aspheric Surface 42 | 2.398 | 2.643 | AIR |
| L43 | Spheric Surface | −10.939 | 2.162 | SNSL36_OHARA |
| | Spheric Surface | 5.025 | 0.002 | Adhesive |
| L44 | Plane | 5.025 | 1.976 | SLAH66_OHARA |
| | Spheric Surface | −8.036 | 0.700 | AIR |
| S4 | Spheric Surface | Plane | 0.800 | AIR |
| L45 | Plane | 7.369 | 4.242 | SFPM2_OHARA |
| | Spheric Surface | −3.322 | 0.002 | Adhesive |
| L46 | Spheric Surface | −3.322 | 0.600 | STIH53W_OHARA |
| | Spheric Surface | −8.357 | 1.707 | AIR |
| L47 | Aspheric Surface 43 | −200.010 | 3.422 | MBACD12 |
| | Aspheric Surface 44 | −26.619 | 0.571 | AIR |
| IRCF | Plane | Plane | 0.400 | IRCF |
| | Plane | Plane | 0.410 | AIR |
| CG | Plane | Plane | 0.500 | CG |
| | Plane | Plane | 0.435 | AIR |
| IM4 | Plane | Plane | 0.000 | — |

NUMERICAL DATA AT LOW TEMPERATURE (−40 ° C.)

| | | r | d | Glass Material |
|---|---|---|---|---|
| Object Surface | | — | 2000.000 | ‘AIRT2’ |
| L41 | Spheric Surface | 34.151 | 1.999 | ‘SLAL21T2’ |
| | Spheric Surface | 10.119 | 0.841 | ‘AIRT2’ |
| L42 | Aspheric Surface 41 | 4.941 | 1.584 | ‘BACD12T2’ |
| | Aspheric Surface 42 | 2.397 | 2.642 | ‘AIRT2’ |
| L43 | Spheric Surface | −10.933 | 2.161 | ‘SNSL36T2’ |
| | Spheric Surface | 5.023 | 0.002 | Adhesive |
| L44 | Plane | 5.023 | 1.975 | ‘SLAH66T2’ |
| | Spheric Surface | −8.034 | 0.697 | ‘AIRT2’ |
| S4 | Spheric Surface | Plane | 0.796 | ‘AIRT2’ |
| L45 | Plane | 7.362 | 4.239 | ‘SFPM2T2’ |
| | Spheric Surface | −3.320 | 0.002 | Adhesive |
| L46 | Spheric Surface | −3.320 | 0.600 | ‘TIH53WT2’ |
| | Spheric Surface | −8.351 | 1.703 | ‘AIRT2’ |
| L47 | Aspheric Surface 43 | −199.929 | 3.421 | ‘BACD12T2’ |
| | Aspheric Surface 44 | −26.608 | 0.573 | ‘AIRT2’ |
| IRCF | Plane | Plane | 0.400 | IRCF |
| CG | Plane | Plane | 0.409 | ‘AIRT2’ |
| | Plane | Plane | 0.500 | CG |
| | Plane | Plane | 0.434 | ‘AIRT2’ |
| IM4 | Plane | Plane | 0.000 | — |

NUMERICAL DATA AT HIGH TEMPERATURE (+85 ° C.)

| | | r | d | Glass Material |
|---|---|---|---|---|
| Object Surface | | — | 2000.000 | ‘AIRT3’ |
| L41 | Spheric Surface | 34.172 | 2.001 | ‘SLAL21T3’ |
| | Spheric Surface | 10.125 | 0.849 | ‘AIRT3’ |
| L42 | Aspheric Surface 41 | 4.945 | 1.585 | ‘BACD12T3’ |
| | Aspheric Surface 42 | 2.399 | 2.644 | ‘AIRT3’ |
| L43 | Spheric Surface | −10.946 | 2.163 | ‘SNSL36T3’ |
| | Spheric Surface | 5.027 | 0.002 | Adhesive |
| L44 | Plane | 5.027 | 1.977 | ‘SLAH66T3’ |
| | Spheric Surface | −8.039 | 0.703 | ‘AIRT3’ |
| S4 | Spheric Surface | Plane | 0.804 | ‘AIRT3’ |
| L45 | Plane | 7.376 | 4.245 | ‘SFPM2T3’ |
| | Spheric Surface | −3.324 | 0.002 | Adhesive |
| L46 | Spheric Surface | −3.324 | 0.600 | ‘TIH53WT3’ |
| | Spheric Surface | −8.364 | 1.711 | ‘AIRT3’ |
| L47 | Aspheric Surface 43 | −200.102 | 3.424 | ‘BACD12T3’ |
| | Aspheric Surface 44 | −26.631 | 0.569 | ‘AIRT3’ |
| IRCF | Plane | Plane | 0.400 | IRCF |
| | Plane | Plane | 0.411 | ‘AIRT3’ |
| CG | Plane | Plane | 0.500 | CG |
| | Plane | Plane | 0.436 | ‘AIRT3’ |
| IM4 | Plane | Plane | 0.000 | — |

ASPHERIC COEFFICIENTS WHEN TEMPERATURE FLUCTUATES

| | | | |
|---|---|---|---|
| Aspheric | Aspheric | Aspheric | Aspheric |
| Surface 41 | Surface 42 | Surface 43 | Surface 44 |

+25° C.

| | | | | |
|---|---|---|---|---|
| R | 4.943 | 2.398 | −200.010 | −26.619 |
| k | −1.911 | −0.524 | 0.000 | 0.000 |
| A | 3.4299E−03 | 4.7376E−03 | 1.7904E−04 | 7.9926E−03 |
| B | −1.3523E−04 | 1.9464E−03 | −1.3490E−03 | −2.8155E−03 |
| C | −8.7971E−05 | −1.7053E−03 | 3.2178E−04 | 3.1889E−04 |
| D | 9.5122E−06 | 3.8057E−04 | −4.5069E−05 | −2.0386E−05 |
| E | −4.0146E−07 | −4.0090E−05 | 3.1559E−06 | 7.0575E−07 |
| F | 6.4620E−09 | 1.6863E−06 | −8.8137E−08 | −1.0266E−08 |
| G | 0.0000E+00 | 0.0000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

−40° C.

| | | | | |
|---|---|---|---|---|
| R | 4.941 | 2.397 | −199.929 | −26.608 |
| k | −1.911 | −0.524 | 0.000 | 0.000 |
| A | 3.4341E−03 | 4.7434E−03 | 1.7926E−04 | 8.0023E−03 |
| B | −1.3551E−04 | 1.9504E−03 | −1.3517E−03 | −2.8213E−03 |
| C | −8.8222E−05 | −1.7102E−03 | 3.2270E−04 | 3.1980E−04 |
| D | 9.5471E−06 | 3.8197E−04 | −4.5234E−05 | −2.0460E−05 |
| E | −4.0326E−07 | −4.0270E−05 | 3.1701E−06 | 7.0891E−07 |
| F | 6.4963E−09 | 1.6952E−06 | −8.8604E−08 | −1.0320E−08 |
| G | 0.0000E+00 | 0.00000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

+85° C.

| | | | | |
|---|---|---|---|---|
| R | 4.945 | 2.399 | −200.102 | −26.631 |
| k | −1.911 | −0.524 | 0.000 | 0.000 |
| A | 3.4252E−03 | 4.7311E−03 | 1.7879E−04 | 7.9815E−03 |
| B | −1.3492E−04 | 1.9419E−03 | −1.3459E−03 | −2.8091E−03 |
| C | −8.7688E−05 | −1.6999E−03 | 3.2075E−04 | 3.1787E−04 |
| D | 9.4730E−06 | 3.7900E−04 | −4.4883E−05 | −2.0302E−05 |
| E | −3.9944E−07 | −3.9888E−05 | 3.1400E−06 | 7.0219E−07 |
| F | 6.4236E−09 | 1.6762E−06 | −8.7612E−08 | −1.0205E−08 |
| G | 0.0000E+00 | 0.00000E+00 | 0.0000E+00 | 0.0000E+00 |
| H | 0.00000E+00 | 0.00000E+00 | 0.0000E+00 | 0.0000E+00 |
| I | 0.00000E+00 | 0.00000E+00 | 0.0000E+00 | 0.0000E+00 |

REFRACTIVE INDEX WHEN TEMPERATURE FLUCTUATES

| | WAVELENGTH (nm) | | |
|---|---|---|---|
| GLASS NAME | 680 | 587.56 | 470 |
| SLAL21_OHARA | 1.697817 | 1.703 | 1.714471 |
| MBACD12_HOYA | 1.579291 | 1.58313 | 1.591455 |
| SNSL36_OHARA | 1.513609 | 1.517417 | 1.525865 |
| SLAH66_OHARA | 1.766477 | 1.772499 | 1.78581 |
| SFPM2_OHARA | 1.591805 | 1.59522 | 1.602703 |
| STIH53W_OHARA | 1.833727 | 1.84666 | 1.878166 |
| SBSL7_OHARA | 1.513149 | 1.51633 | 1.523134 |
| ‘AIRT2’ | 1.000341 | 1.000343 | 1.000346 |
| ‘AIRT3’ | 1.000222 | 1.000223 | 1.000225 |
| ‘SLAL21T2’ | 1.69792 | 1.703087 | 1.714517 |
| ‘SLAL21T3’ | 1.698647 | 1.703853 | 1.715381 |
| ‘BACD12T2’ | 1.579607 | 1.583436 | 1.591738 |
| ‘BACD12T3’ | 1.579872 | 1.583729 | 1.592094 |
| ‘SNSL36T2’ | 1.513987 | 1.517784 | 1.526201 |
| ‘SNSL36T3’ | 1.514079 | 1.517905 | 1.526398 |
| ‘SLAH66T2’ | 1.766827 | 1.772834 | 1.786108 |
| ‘SLAH66T3’ | 1.76713 | 1.773175 | 1.786544 |
| ‘SFPM2T2’ | 1.592724 | 1.596133 | 1.6036 |
| ‘SFPM2T3’ | 1.591787 | 1.595214 | 1.602726 |
| ‘TIH53WT2’ | 1.834336 | 1.847225 | 1.87859 |
| ‘TIH53WT3’ | 1.83417 | 1.847165 | 1.878857 |
| ‘SBSL7T2’ | 1.513513 | 1.516687 | 1.523472 |
| ‘SBSL7T3’ | 1.513642 | 1.516836 | 1.523673 |

NUMERICAL EXAMPLE 5
NUMERICAL DATA AT ROOM TEMPERATURE (+25 ° C.)

| | | r | d | Glass Material |
|---|---|---|---|---|
| Object Surface | | — | 2000.000 | AIR |
| L51 | Spheric Surface | 17.980 | 1.546 | SLAL21_OHARA |
| | Spheric Surface | 9.400 | 0.500 | |
| L52 | Aspheric Surface 21 | 4.236 | 1.262 | MBACD12_HOYA |
| | Aspheric Surface 22 | 1.768 | 1.452 | AIR |
| L53 | Spheric Surface | Plane | 1.000 | LBSL7_OHARA |
| | Spheric Surface | 3.210 | 0.443 | AIR |
| | Plane | Plane | 0.200 | AIR |
| L54 | Spheric Surface | 4.699 | 2.698 | SBAL3_OHARA |
| | Spheric Surface | −3.767 | 0.200 | AIR |
| S5 | Plane | Plane | 0.348 | AIR |
| L55 | Spheric Surface | 6.128 | 3.664 | SPHM52_OHARA |
| | Spheric Surface | −3.082 | 0.000 | Adhesive |
| L56 | Spheric Surface | −3.082 | 1.129 | STIH53W_OHARA |
| | Spheric Surface | −75.031 | 0.503 | AIR |
| L57 | Aspheric Surface 23 | 5.826 | 2.536 | MBACD12_HOYA |
| | Aspheric Surface 24 | −64.896 | 0.777 | AIR |
| IRCF | Plane | Plane | 0.400 | IRCF |
| | Plane | Plane | 0.540 | AIR |
| CG | Plane | Plane | 0.400 | CG |
| | Plane | Plane | 0.150 | AIR |
| IM5 | Plane | Plane | — | — |

NUMERICAL DATA AT LOW TEMPERATURE (−40 ° C.)

| | | r | d | Glass Material |
|---|---|---|---|---|
| Object Surface | | — | 2000.000 | ‘AIRT2’ |
| L51 | Spheric Surface | 17.975 | 1.546 | SLAL21_OHARA |
| | Spheric Surface | 9.397 | 0.495 | ‘AIRT2’ |
| L52 | Aspheric Surface 21 | 4.234 | 1.262 | ‘BACD12T2’ |
| | Aspheric Surface 22 | 1.767 | 1.451 | ‘AIRT2’ |
| L53 | Spheric Surface | Plane | 1.000 | |
| | Spheric Surface | 3.208 | 0.443 | ‘AIRT2’ |
| | Plane | Plane | 0.198 | ‘AIRT2’ |
| L54 | Spheric Surface | 4.696 | 2.696 | ‘SBAL3T2’ |
| | Spheric Surface | −3.765 | 0.198 | ‘AIRT2’ |
| S5 | Plane | Plane | 0.345 | ‘AIRT2’ |
| L55 | Spheric Surface | 6.123 | 3.661 | ‘SPHM52T2’ |
| | Spheric Surface | −3.080 | 0.002 | Adhesive |
| L56 | Spheric Surface | −3.080 | 1.128 | ‘TIH53WT2’ |
| | Spheric Surface | −75.086 | 0.503 | ‘AIRT2’ |
| L57 | Aspheric Surface | 5.823 | 2.535 | ‘BACD12T2’ |
| | 23 | | | |
| | Aspheric Surface | −64.869 | 0.774 | ‘AIRT2’ |
| | 24 | | | |
| IRCF | Plane | Plane | 0.400 | IRCF |
| | Plane | Plane | 0.538 | ‘AIRT2’ |
| CG | Plane | Plane | 0.400 | CG |
| | Plane | Plane | 0.150 | ‘AIRT2’ |
| IM5 | Plane | Plane | — | — |

NUMERICAL DATA AT HIGH TEMPERATURE (+85 ° C.)

| | | r | d | Glass Material |
|---|---|---|---|---|
| Object Surface | | — | 2000.000 | ‘AIRT3’ |
| L51 | Spheric Surface | 17.986 | 1.547 | SLAL21_OHARA |
| | Spheric Surface | 9.403 | 0.504 | ‘AIRT3’ |
| L52 | Aspheric Surface 21 | 4.238 | 1.263 | ‘BACD12T3’ |
| | Aspheric Surface 22 | 1.769 | 1.453 | ‘AIRT3’ |
| L53 | Spheric Surface | Plane | 1.000 | ‘LBSL7T3’ |
| | Spheric Surface | 3.211 | 0.443 | ‘AIRT3’ |
| | Plane | Plane | 0.202 | ‘AIRT3’ |
| L54 | Spheric Surface | 4.702 | 2.699 | ‘SBAL3T3’ |
| | Spheric Surface | −3.769 | 0.202 | ‘AIRT3’ |
| S5 | Plane | Plane | 0.351 | ‘AIRT3’ |
| L55 | Spheric Surface | 6.133 | 3.666 | ‘SPHM52T3’ |
| | Spheric Surface | −3.083 | 0.002 | Adhesive |
| L56 | Spheric Surface | −3.083 | 1.130 | ‘TIH53WT3’ |
| | Spheric Surface | −74.975 | 0.507 | ‘AIRT3’ |
| L57 | Aspheric Surface 23 | 5.828 | 2.537 | ‘BACD12T3’ |
| | Aspheric Surface | −64.925 | 0.780 | ‘AIRT3’ |
| | 24 | | | |
| IRCF | Plane | Plane | 0.400 | IRCF |
| | Plane | Plane | 0.542 | ‘AIRT3’ |
| CG | Plane | Plane | 0.400 | CG |
| | Plane | Plane | 0.150 | ‘AIRT3’ |
| IM5 | Plane | Plane | — | — |

ASPHERIC COEFFICIENTS WHEN TEMPERATURE FLUCTUATES

| | | | |
|---|---|---|---|
| Aspheric | Aspheric | Aspheric | Aspheric |
| Surface 51 | Surface 52 | Surface 53 | Surface 54 |

+25° C.

| | | | | |
|---|---|---|---|---|
| R | 4.236 | 1.768 | 5.826 | −64.896 |
| k | −0.961 | −0.529 | −0.757 | 10.000 |
| A | 4.8671E−03 | 5.0100E−03 | 3.8494E−03 | 2.0469E−02 |
| B | −1.0868E−03 | 4.5665E−02 | −4.7676E−03 | −1.1495E−02 |
| C | −4.5531E−04 | −1.0320E−01 | 1.8831E−03 | 2.6378E−03 |
| D | 6.0879E−05 | 1.1146E−01 | −4.2097E−04 | −3.2048E−04 |
| E | 1.3044E−05 | −7.3820E−02 | 5.2532E−05 | 1.7533E−05 |
| F | −3.8438E−06 | 3.0498E−02 | −3.4575E−06 | −8.7253E−08 |
| G | 3.8771E−07 | −7.5943E−03 | 9.2852E−08 | −1.9319E−08 |
| H | −1.82186E−08 | 1.03919E−03 | 0.0000E+00 | 0.0000E+00 |
| I | 3.35082E−10 | −5.98857E−05 | 0.0000E+00 | 0.0000E+00 |

−40° C.

| | | | | |
|---|---|---|---|---|
| R | 4.234 | 1.767 | 5.823 | −64.869 |
| k | −0.961 | −0.529 | −0.757 | 10.000 |
| A | 4.8731E−03 | 5.0161E−03 | 3.8542E−03 | 2.0494E−02 |
| B | −1.0890E−03 | 4.5758E−02 | −4.7773E−03 | −1.1518E−02 |
| C | −4.5661E−04 | −1.0349E−01 | 1.8884E−03 | 2.6454E−03 |
| D | 6.1102E−05 | 1.1186E−01 | −4.2251E−04 | −3.2166E−04 |
| E | 1.3103E−05 | −7.4151E−02 | 5.2768E−05 | 1.7612E−05 |
| F | −3.8642E−06 | 3.0660E−02 | −3.4759E−06 | −8.7715E−08 |
| G | 3.9009E−07 | −7.64075E−03 | 9.3420E−08 | −1.9437E−08 |
| H | −1.83450E−08 | 1.04641E−03 | 0.0000E+00 | 0.0000E+00 |
| I | 3.37682E−10 | −6.03504E−05 | 0.0000E+00 | 0.0000E+00 |

+85° C.

| | | | | |
|---|---|---|---|---|
| R | 4.238 | 1.769 | 5.828 | −64.925 |
| k | −0.961 | −0.529 | −0.757 | 10.000 |
| A | 4.8604E−03 | 5.0031E−03 | 3.8441E−03 | 2.0441E−02 |
| B | −1.0843E−03 | v 4.5560E−02 | −4.7566E−03 | −1.1469E−02 |
| C | −4.5385E−04 | −1.0287E−01 | 1.8770E−03 | 2.6294E−03 |
| D | 6.0627E−05 | 1.1100E−01 | −4.1923E−04 | −3.1916E−04 |
| E | 1.2978E−05 | −7.3448E−02 | 5.2268E−05 | 1.7445E−05 |
| F | −3.8209E−06 | 3.0317E−02 | −3.4370E−06 | −8.6733E−08 |
| G | 3.8505E−07 | −7.54212E−03 | 9.2214E−08 | −1.9186E−08 |
| H | −1.80769E−08 | 1.03111E−03 | 0.0000E+00 | 0.0000E+00 |
| I | 3.32170E−10 | −5.93653E−05 | 0.0000E+00 | 0.0000E+00 |

REFRACTIVE INDEX WHEN TEMPERATURE FLUCTUATES

| | WAVELENGTH (nm) | | |
|---|---|---|---|
| GLASS NAME | 680 | 587.56 | 470 |
| SLAL21_OHARA | 1.697817 | 1.703 | 1.714471 |
| MBACD12_HOYA | 1.579291 | 1.58313 | 1.591455 |
| STIH53W_OHARA | 1.833727 | 1.84666 | 1.878166 |
| LBSL7_OHARA | 1.513136 | 1.51633 | 1.523132 |
| SBAL3_OHARA | 1.567194 | 1.571351 | 1.58059 |
| SPHM52_OHARA | 1.6142 | 1.618 | 1.626304 |
| NBK7_SCHOTT | 1.513615 | 1.5168 | 1.523605 |
| ‘AIRT2’ | 1.000341 | 1.000343 | 1.000346 |
| ‘AIRT3’ | 1.000222 | 1.000223 | 1.000225 |
| ‘SLAL21T2’ | 1.69792 | 1.703087 | 1.714517 |
| ‘SLAL21T3’ | 1.698647 | 1.703853 | 1.715381 |
| ‘BACD12T2’ | 1.579607 | 1.583436 | 1.591738 |
| ‘BACD12T3’ | 1.579872 | 1.583729 | 1.592094 |
| LBSL7T2’ | 1.51337 | 1.516557 | 1.523341 |
| ‘LBSL7T3’ | 1.513749 | 1.516957 | 1.523792 |
| ‘SBAL3T2’ | 1.56778 | 1.571927 | 1.581138 |
| ‘SBAL3T3’ | 1.567501 | 1.571674 | 1.580958 |
| ‘SPHM52T2’ | 1.614991 | 1.618785 | 1.627074 |
| ‘SPHM52T3’ | 1.614328 | 1.618141 | 1.626479 |
| ‘NBK7T2’ | 1.513971 | 1.517149 | 1.523937 |
| NBK7T3’ | 1.514125 | 1.517324 | 1.524162 |
| ‘TIH53WT2’ | 1.834336 | 1.847225 | 1.87859 |
| ‘TIH53WT3’ | 1.83417 | 1.847165 | 1.878857 |

Table 1 summarizes values of each inequality in Examples 1 to 5. Satisfying each inequality can achieve an optical system that can suppress focus fluctuations caused by temperature fluctuations, even if a linear expansion difference between the lens barrel and the cover material is small.

TABLE 1

| INEQUALITY, | | | | | |
|---|---|---|---|---|---|
| NUMERICAL | | | | | |
| VALUE | EX 1 | EX 2 | EX 3 | EX 4 | EX 5 |
| dndt6-dndt5 | 7.6 | 3.9 | 2.2 | 7.6 | 6.9 |
| dndt3-dndt4 | 5.3 | 3.0 | 3.0 | −2.2 | 3.6 |
| f4/f3 | −0.8 | −0.8 | −0.7 | −0.7 | −0.7 |
| f5/f6 | −1.0 | −1.0 | −0.6 | −0.7 | −1.0 |
| f4/f | 1.3 | 1.3 | 0.8 | 0.9 | 1.3 |
| f5/f | 1.2 | 1.3 | 0.9 | 1.0 | 1.2 |
| f2/f | −2.6 | −2.7 | −2.2 | −2.3 | −1.9 |
| f1/f | −7.6 | −7.6 | −4.5 | −4.6 | −9.2 |
| t | 3.3 | 3.3 | 4.5 | 4.6 | 3.3 |
| ⊖ max | 90 | 90 | 90 | 90 | 60 |
| y(⊖ max) | 2.8 | 2.8 | 3.9 | 3.9 | 2.6 |
| f sin(⊖ max)/ | 1.16 | 1.16 | 1.16 | 1.17 | 1.12 |
| y(⊖ min) | | | | | |
| y(⊖ half) | 2.16 | 2.16 | 3.08 | 3.05 | 1.69 |
| y(⊖ half)/ | 0.77 | 0.77 | 0.79 | 0.78 | 0.66 |
| y(⊖ max) | | | | | |
| LINEAR | 2.60E−05 | 2.60E−05 | 2.60E−05 | 2.60E−05 | 2.60E−05 |
| EXPANSION | | | | | |
| COEFFICIENT | | | | | |
| OF LENS | | | | | |
| BARREL | | | | | |
| MATERIALL | | | | | |
| αₒₚ(1/° C.) | | | | | |
| LINEAR | 2.18E−05 | 2.35E−05 | 2.10E−05 | 2.10E−05 | 2.18E−05 |
| EXPANSION | | | | | |
| COEFFICIENT | | | | | |
| OF COVER | | | | | |
| MATERIAL | | | | | |
| α_{co}(1/° C.) | | | | | |
| αₒₚ/α_{co} | 1.19 | 1.11 | 1.24 | 1.24 | 1.19 |
| OVERALL | 20 | 20 | 25 | 25 | 20 |
| LENS | | | | | |
| LENGTH | | | | | |
| (mm) | | | | | |
| A LENGTH | 10 | 8.9 | 14.6 | 14.6 | 11 |
| (mm) | | | | | |

### Image Pickup Apparatus

FIG. 12 is a schematic diagram of principal part of an image pickup apparatus 70 according to this example. The image pickup apparatus 70 according to this example includes an optical system (imaging optical system) 71 according to any one of the above examples, a light receiving element 72 configured to photoelectrically convert an object image formed by the optical system 71, and a camera body (housing) 73 configured to hold the light receiving element 72. The optical system 71 is held by a lens barrel (holder) and connected to the camera body 73. As illustrated in FIGS. 7A to 7C, a display unit 74 configured to display an image acquired by the light receiving element 72 may be connected to the camera body 73. An image sensor (photoelectric conversion element) such as a CCD sensor or a CMOS sensor can be used as the light receiving element 72.

In a case where the image pickup apparatus 70 is used as a distance measuring apparatus, for example, an image sensor (imaging-surface phase-difference sensor) having pixels that can split a light beam from the object into two and photoelectrically convert it can be used as the light receiving element 72. In a case where the object is located on a front focal plane of the optical system 71, no positional shift occurs between images corresponding to the two split light beams on the image plane of the optical system 71. However, in a case where the object is located at a position other than the front focal plane of the optical system 71, a positional shift occurs between the images. In this case, a positional shift of each image corresponds to a displacement amount from the front focal plane of the object, so a distance to the object can be measured by acquiring a positional shift amount and a positional shift direction of each image using an imaging-surface phase-difference sensor.

The optical system 71 and the camera body 73 may be attachable to and detachable from each other. That is, the optical system 71 and the lens barrel may be configured as an interchangeable lens (lens apparatus). The optical system according to each of the above examples can be applied not only to image pickup apparatuses such as digital still cameras, film-based cameras, video cameras, on-board cameras, and surveillance cameras, but also to various optical apparatuses such as telescopes, binoculars, projectors (projection apparatuses), and digital copiers.

### On-Board System

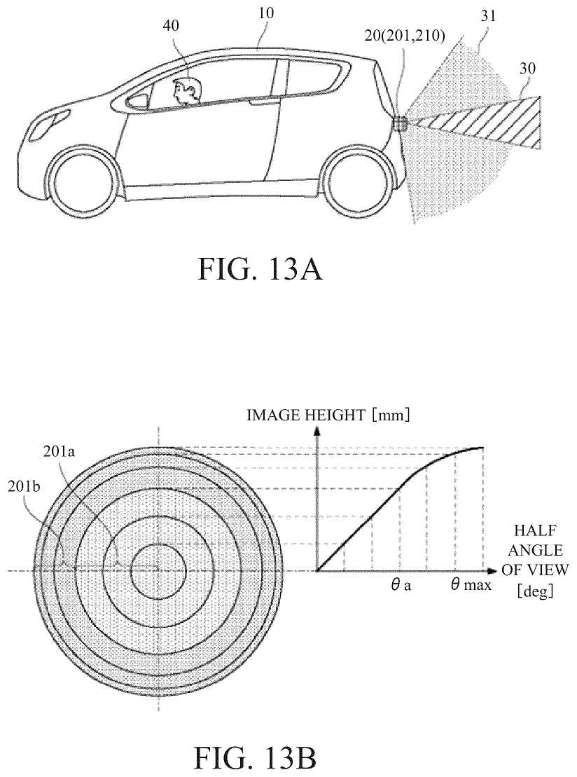

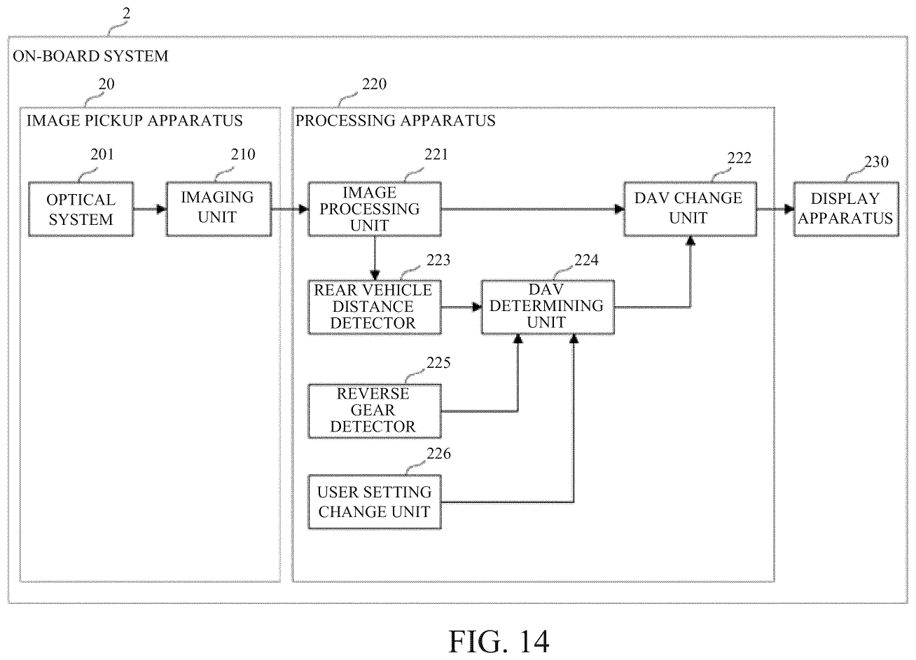

FIG. 13A is a schematic diagram of a movable apparatus 10 according to this example and an image pickup apparatus 20 (on-board camera) held by it. FIG. 13A illustrates a case where the movable apparatus 10 is an automobile (vehicle). The movable apparatus 10 includes an unillustrated in-vehicle system (driving support device) for supporting a user 40 (driver, passenger, etc.) of the movable apparatus 10 using an image acquired by the image pickup apparatus 20. In this embodiment, the image pickup apparatus 20 is installed so as to image the rear of the movable apparatus 10, but the image pickup apparatus 20 may be installed so as to capture the front or side of the movable apparatus 10. In addition, two or more image pickup apparatuses 20 may be installed at two or more locations on the movable apparatus 10.

The image pickup apparatus 20 includes an optical system 201 and an imaging unit 210 according to any of the above examples. The optical system 201 is an optical system (different-angle-of-view lens) in which an imaging magnification at a first angle of view (first field of view) 30 and an imaging magnification at a second angle of view (second field of view) 31 larger than the first angle of view 30 are different. The imaging surface (light receiving surface) of the imaging unit 210 includes a first area for imaging an object included in the first angle of view 30 and a second area for imaging an object included in the second angle of view 31. In this case, the number of pixels per unit angle of view in the first area is larger than the number of pixels per unit angle of view in the second area excluding the first area. In other words, the resolution of the image pickup apparatus 20 at the first angle of view (in the first area) is higher than the resolution at the second angle of view (in the second area).

A detailed description will now be given of the optical characteristic of the optical system 201. A left diagram in FIG. 13B illustrates an image height y [mm] at each half angle of view θ [deg.] on the imaging surface of the imaging unit 210 in the form of contour lines. A right diagram in FIG. 13B illustrates a relationship between each half angle of view θ and image height y in the first quadrant of the left diagram (projection characteristic of the optical system 201) in a graph.

As illustrated in FIG. 13B, the optical system 201 is configured such that the projection characteristic y(θ) differs between an angle of view less than a predetermined half angle of view θa and an angle of view equal to or larger than the half angle of view θa. Therefore, an increase amount in image height y per unit relative to a half angle of view θ (resolution) also differs for each angle of view. The local resolution of the optical system 201 is expressed as a differential value dy(θ)/dθ of the projection characteristic y(θ) relative to the half angle of view θ. In the left diagram of FIG. 13B, as an interval between the contour lines of the image height y relative to each half angle of view θ increases, the resolution becomes higher. In the right diagram of FIG. 13B, as a slope of the graph of the projection characteristic y(θ) increases, the resolution becomes higher.

In the left diagram of FIG. 13B, a first area 201a, which is a central area, corresponds to an angle of view less than the half angle of view θa, and a second area 201b, which is a peripheral area, corresponds to an angle of view equal to or larger than the half angle of view θa. The angle of view less than the half angle of view θa corresponds to the first angle of view 30 in FIG. 13A, and the angle of view obtained by combining the angle of view less than the half angle of view θa and the angle of view equal to or larger than the half angle of view θa corresponds to the second angle of view 31 in FIG. 13A. As described above, the first area 201a is an area with high resolution and low distortion, and the second area 201b is an area with low resolution and high distortion.

A value of a ratio θa/θmax of a half angle of view θa to a maximum half angle of view θmax may be 0.15 or more and 0.35 or less, or 0.16 or more and 0.25 or less. In each of the above examples, since the maximum half angle of view θmax is 90° or 60°, for example, the value of the half angle of view θa may be 13.5° or more and 31.5° or less, or 9.0° or more and 21.0° or less. The value of the half angle of view θa may be 14.4° or more and 22.5° or less, or 9.6° or more and 15.0° or less.

The optical system according to this embodiment may satisfy the following inequality (10):

$$1. < f \times sin ( θ max ) / y ( θ max ) \leq 1.9 \qquad ( 10 )$$

where θ [deg.] is a half angle of view of the optical system, y(θ) is a projection characteristic expressing a relationship between the half angle of view θ and the image height y, θmax is a maximum half angle of view of the optical system, and f is a focal length of the optical system (entire optical system).

The optical system that satisfies inequality (10) can improve the resolution of the object image at an angle of view near the optical axis OA while maintaining a wide angle of view.

Inequality (10) may be replaced with inequality (10a) below:

$$1. < f \times sin ( θ max ) / y ( θ max ) \leq 1.7 \qquad ( 10 a )$$

Inequality (10) may be replaced with inequality (10b) below:

$$1. 0 < f \times sin ( θmax ) / y ( θ max ) \leq 1.4 \qquad ( 10 b )$$

The optical system according to this embodiment may satisfy the following inequality (11):

$$0.65 < y ( θmax / 2 ) / y ( θ max ) < 0.85 \qquad ( 11 )$$

Inequality (11) defines a ratio between the image height y(θmax) at the maximum half angle of view θmax and the image height y(θmax/2) at the angle of view θmax/2, which is half the maximum half angle of view θmax. Satisfying inequality (11) can improve the resolution of the object image at an angle of view near the optical axis OA while maintaining a wide angle of view.

Inequality (11) may be replaced with inequality (11a) below:

$$0.65 < y ( θmax / 2 ) / y ( θ max ) < 0.83 \qquad ( 11 a )$$

Inequality (11) may be replaced with inequality (11b) below:

$$0.65 < y ( θmax / 2 ) / y ( θ max ) < 0.81 \qquad ( 11 b )$$

As described above, in the first area 201a, the distortion of the optical system 201 is small and the resolution is high, so that a higher definition image can be obtained than that in the second area 201b. Therefore, good visibility can be obtained by setting the first area 201a (first angle of view 30) to be a target area of the user 40. For example, as illustrated in FIG. 13A, in a case where the image pickup apparatus 20 is disposed at the rear of the movable apparatus 10, a natural perspective sense can be obtained in a case where the user 40 gazes at a rear vehicle or the like by displaying an image corresponding to the first angle of view 30 on the electronic rearview mirror. On the other hand, the second area 201b (second angle of view 31) corresponds to a wide angle of view including the first angle of view 30. Therefore, for example, when the movable apparatus 10 is running backward, an image corresponding to the second angle of view 31 is displayed on the in-vehicle display to assist the user 40 in driving.

FIG. 14 is a functional block diagram for explaining an example configuration of the on-board system 2 according to this embodiment. The on-board system 2 is a system for displaying to the user 40 an image obtained by the image pickup apparatus 20 installed at the rear of the movable apparatus 10. The on-board system 2 includes the image pickup apparatus 20, a processing apparatus 220, and a display apparatus (display unit) 230. The image pickup apparatus 20 includes the optical system 201 and the imaging unit 210 as described above. The imaging unit 210 includes an image sensor such as a CCD sensor or a CMOS sensor, and generates imaging data by photoelectrically converting an optical image formed by the optical system 201, and outputs the imaging data to the processing apparatus 220.

The processing apparatus 220 includes an image processing unit 221, a display-angle-of-view (DAV) determining unit 224, a user setting change unit 226 (first change unit), a rear vehicle distance detector 223 (first detector), a reverse gear detector 225 (second detector), and a DAV change unit 222 (second change unit). The processing apparatus 220 is a computer such as a Central Processing Unit (CPU) microcomputer, and functions as a control unit that controls the operation of each component based on a computer program. At least one of the components of the processing apparatus 220 may be realized by hardware such as an Application Specific Integrated Circuit (ASIC) or a Programmable Logic Array (PLA).

The image processing unit 221 generates image data by performing image processing such as Wide Dynamic Range (WDR) correction, gamma correction, Look Up Table (LUT) processing, and distortion correction for the image data acquired from the imaging unit 210. The distortion is corrected on at least the image data corresponding to the second area 201b. Thereby, the user 40 is likely to visually recognize an image when it is displayed on the display apparatus 230, and also improves a detection rate of the rear vehicle in the rear vehicle distance detector 223. The distortion correction does not have to be performed on the image data corresponding to the first area 201a. The image processing unit 221 outputs the image data generated by executing the image processing as described above to the DAV change unit 222 and the rear vehicle distance detector 223.

The rear vehicle distance detector 223 acquires information on a distance to a rear vehicle included in the image data corresponding to a range of the second angle of view 31 that does not include the first angle of view 30, using the image data output from the image processing unit 221. For example, the rear vehicle distance detector 223 can detect a rear vehicle based on image data corresponding to the second area 201b among the image data, and calculate a distance to his vehicle from changes in the position and size of the detected rear vehicle. The rear vehicle distance detector 223 outputs information on the calculated distance to the DAV determining unit 224.

The rear vehicle distance detector 223 may further determine a vehicle type of the rear vehicle based on data on characteristic information such as a shape and color for each vehicle type output as a result of machine learning (deep learning) based on an image of a large number of vehicles. At this time, the rear vehicle distance detector 223 may output information on the vehicle type of the rear vehicle to the DAV determining unit 224. The reverse gear detector 225 detects whether the transmission of the movable apparatus 10 (user's vehicle) is in the reverse gear, and outputs the detection result to the DAV determining unit 224.

The DAV determining unit 224 determines whether the angle of view (display angle of view) of the image to be displayed on the display apparatus 230 is to be the first angle of view 30 or the second angle of view 31 based on an output from at least one of the rear vehicle distance detector 223 and the reverse gear detector 225. Then, the DAV determining unit 224 outputs a predetermined result to the DAV change unit 222 according to the determination result. For example, the DAV determining unit 224 can determine that the display angle of view is to be the second angle of view 31 in a case where a distance value in the distance information is equal to or smaller than a certain threshold value (e.g., 3 m), and can determine that the display angle of view is to be the first angle of view 30 in a case where the distance value is larger than the threshold value. Alternatively, the DAV determining unit 224 can determine that the display angle of view is to be the second angle of view 31 in a case where the reverse gear detector 225 notifies the user that the transmission of the movable apparatus 10 is in the reverse gear. The DAV determining unit 224 can determine that the display angle of view is to be the first angle of view 30 in a case where the vehicle is not in the reverse gear.

The DAV determining unit 224 can determine that the display angle of view is to be the second angle of view 31 in a case where the transmission of the movable apparatus 10 is in the reverse gear, regardless of the result of the rear vehicle distance detector 223. The DAV determining unit 224 can determine that the display angle of view is to be determined according to the detection result of the rear vehicle distance detector 223 in a case where the transmission of the movable apparatus 10 is not in the reverse gear. The DAV determining unit 224 may change the determination criterion for changing the angle of view according to the vehicle type of the movable apparatus 10 by receiving vehicle type information from the rear vehicle distance detector 223. For example, in a case where the movable apparatus 10 is a large vehicle such as a truck, its braking distance is longer than that of a standard vehicle, so the above threshold value may be set larger than that of the standard vehicle (for example, 10 m).

The user setting change unit 226 allows the user 40 to change the determination criteria for determining whether or not the display angle of view is changed to the second angle of view 31 by the DAV determining unit 224. The determination criteria set (changed) by the user 40 are input from the user setting change unit 226 to the DAV determining unit 224.

The DAV change unit 222 generates a display image to be displayed on the display apparatus 230 according to the determination result by the DAV determining unit 224. For example, in a case where it is determined that the first angle of view 30 is to be used, the DAV change unit 222 cuts out a rectangular sandwiched angle image (first image) from the image data corresponding to the first angle of view 30 and outputs it to the display apparatus 230. In a case where a rear vehicle that satisfies a predetermined condition is present in image data corresponding to the second angle of view 31, the DAV change unit 222 outputs an image (second image) including the rear vehicle to the display apparatus 230. The second image may include an image corresponding to the first area 201a. The DAV change unit 222 functions as a display control unit configured to perform display control for switching between a first display state in which the display apparatus 230 displays a first image and a second display state in which the display apparatus 230 displays a second image.

The DAV change unit 222 cuts out an image by storing the image data output from the image processing unit 221 in a storage unit (memory) such as a RAM, and by reading out the image to be cut out from there. An area in the image data that corresponds to the first image is a rectangular area at the first angle of view 30 that corresponds to the first area 201a. An area in the image data that corresponds to the second image is a rectangular area including the rear vehicle at the second angle of view 31 that corresponds to the second area 201b.

The display apparatus 230 includes a display unit such as a liquid crystal display or an organic EL, and displays a display image output from the DAV change unit 222. For example, the display apparatus 230 includes a first display unit as an electronic rearview mirror disposed above the windshield (front glass) of the movable apparatus 10, and a second display unit as an operation panel (monitor) disposed below the windshield of the movable apparatus 10. This configuration can display the first image and the second image generated from the image data described above on the first display unit and the second display unit, respectively. The first display unit may include a half-mirror so that it may function as a mirror in a case where it is not used as a display unit. The second display unit may serve as a display unit for a navigation system or an audio system, for example.

The movable apparatus 10 is not limited to a vehicle such as an automobile, but may be a movable unit such as a ship, an aircraft, an industrial robot, or a drone. The on-board system 2 according to this embodiment is used to display an image to the user 40, but is not limited to this example. For example, the on-board system 2 may also be used for driving assistance such as cruise control (including an adaptive cruise control function) and automatic driving. The on-board system 2 is not limited to a movable unit and is applicable to various devices that use object recognition, such as an intelligent transport system (ITS).

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical system that can maintain good optical performance even if the environmental temperature fluctuates. That is, each example can provide an optical system that can achieve both the corrections of focus position fluctuations caused by changes in environmental temperature and the corrections of various aberrations.

This application claims priority to Japanese Patent Application No. 2023-204485, which was filed on Dec. 4, 2023, and which is hereby incorporated by reference herein in its entirety.

What is claimed is:

1. An optical system comprising, in order from an object side to an image side:
a first lens having negative refractive power;
a second lens having negative refractive power;
a third lens having negative refractive power;
a fourth lens having positive refractive power;
an aperture stop;
a fifth lens having positive refractive power;
a sixth lens having negative refractive power; and
a seventh lens,
wherein a sign of a temperature coefficient of a refractive index for d-line of at least one of the fourth lens and the fifth lens at 20° C. to 40° C. is negative, and
wherein a sign of a temperature coefficient of a refractive index for the d-line of at least one of the third lens and the sixth lens at 20° C. to 40° C. is positive.

2. The optical system according to claim 1, wherein the following inequality is satisfied:
$$1.1 < d ndt 6 - dndt 5 < 11.4$$
where dndt5 [10⁻⁶/° C.] is a temperature coefficient of a refractive index of the fifth lens for the d-line at 20° C. to 40° C., and dndt6 [10⁻⁶/° C.] is a temperature coefficient of a refractive index of the sixth lens for the d-line at 20° C. to 40° C.

3. The optical system according to claim 1, wherein the following inequality is satisfied:
$$- 3.3 < d ndt 3 - dndt 4 < 8.$$
where dndt3 is a temperature coefficient of a refractive index for the d-line of the third lens at 20° C. to 40° C., and dndt4 is a temperature coefficient of a refractive index for the d-line of the fourth lens at 20° C. to 40° C.

4. The optical system according to claim 1, wherein the following inequality is satisfied:
$$- 1.5 < f 5 / f 6 < - 0.9$$
where f5 is a focal length of the fifth lens, and f6 is a focal length of the sixth lens.

5. The optical system according to claim 1, wherein the following inequality is satisfied:
$$- 1.1 < f 4 / f 3 < - 0.6$$
where f3 is a focal length of the third lens, and f4 is a focal length of the fourth lens.

6. The optical system according to claim 1, wherein the following inequality is satisfied:
$$0.4 < f 4 / f < 2.0$$
where f4 is a focal length of the fourth lens, and f is a focal length of the optical system.

7. The optical system according to claim 1, wherein the following inequality is satisfied:
$$0.5 < f 5 / f < 1.9$$
where f5 is a focal length of the fifth lens, and f is a focal length of the optical system.

8. The optical system according to claim 1, wherein the second lens is an aspheric lens, and
wherein the following inequality is satisfied:
$$- 4.0 < f 2 / f < - 1.$$
where f2 is a focal length of the second lens, and f is a focal length of the optical system.

9. The optical system according to claim 1, wherein the following inequality is satisfied:
$$- 13.7 < f 1 / f < - 6.8$$
where f1 is a focal length of the first lens, and f is a focal length of the optical system.

10. The optical system according to claim 1, wherein the second lens is an aspheric lens.

11. The optical system according to claim 1, wherein the following inequality is satisfied:
$$1. < {α}_{op} / {α}_{c o} < 1.4$$
where αₒₚ [10⁻⁶/° C.] is a linear expansion coefficient of a lens barrel, and α_{co} [10⁻⁶/° C.] is a linear expansion coefficient of a cover material connecting the lens barrel and an image sensor.

12. The optical system according to claim 11, wherein a distance from an adhesive portion between the cover material and the lens barrel to an imaging surface of the image sensor is smaller than a distance from the first lens to the imaging surface.

13. The optical system according to claim 1, wherein the following inequality is satisfied:
$$1. < f \times sin ( θmax ) / y ( θ max ) \leq 1.9$$
where θ [deg.] is a half angle of view of the optical system, y(θ) is a projection characteristic expressing a relationship between the half angle of view θ and an image height y, and θmax is a maximum half angle of view of the optical system.

14. The optical system according to claim 1, wherein the following inequality is satisfied:
$$0.65 < y ( θmax / 2 ) / y ( θ max ) < 0.85$$
wherein θ [deg.] is a half angle of view of the optical system, y(θ) is a projection characteristic expressing a relationship between the half angle of view θ and an image height y, and θmax is a maximum half angle of view of the optical system.

15. An image pickup apparatus comprising:
the optical system according to claim 1; and
an image sensor configured to capture an object via the optical system.

16. An on-board system comprising:
the image pickup apparatus according to claim 15; and
a display apparatus configured to display an image acquired based on an output from the image pickup apparatus.

17. A movable apparatus comprising:
the image pickup apparatus according to claim 15,
wherein the movable apparatus is configured to hold and move the image pickup apparatus.
